(19) United States
(12) Patent Application Publication
(10) Pub. No.: US 2005/0041642 A1
(43) Pub. Date: Feb. 24, 2005

(54) Method, apparatus and system providing improved voice routing capabilities

(76) Inventor: Jeffrey I. Robinson, New Fairfield, CT (US)

Correspondence Address: GORDON & JACOBSON, P.C., 65 WOODS END ROAD, STAMFORD, CT, 06905, US

(21) Appl. No.: 10/651,090

(22) Filed: Aug. 18, 2003

(51) Int. Cl. H04L 12/66

(52) U.S. Cl. 370/352

(57) ABSTRACT

A telephony system for a premises includes lines operably coupled to telephony devices, and trunks operably coupled to diverse networks (such as the PSTN network and an Internet-based VOIP network). A voice router includes a switch matrix operably coupled between the lines and trunks. In processing an outgoing voice call placed on a particular line, switch control means controls the switch matrix to connect the particular line to at least two trunks (preferably in accordance with at least one routing table). The switch control means analyzes DTMF digit data (corresponding to DTMF digit tone(s) generated on the line) to determine a classification tag for the outgoing voice call, and disconnects the particular line from at least one trunk based upon the classification tag to enable the outgoing voice call to proceed over another one of the at least two trunks. An incoming voice call received over a particular trunk is connected to one or more lines by the switch matrix (preferably in accordance with at least one routing table).

### BACKGROUND OF THE INVENTION

1. Field of the Invention

This invention relates broadly to telephone systems and methods. More particularly, this invention relates to telephone systems that employ both traditional PSTN-based calls and Internet-based VOIP calls.

2. State of the Art

Internet-based VOIP calls are typically less expensive to a user than traditional PSTN-based calls, especially so for long distance calls and international calls. However, the technology utilized to realize the Internet-based VOIP network currently has limitations. For example, the quality-of-service of the Internet-based VOIP network can vary as a result of wide dynamic changes in latency, jitter and/or packet loss of the network, and the connection to the Internet-based VOIP network is unavailable in the event of power failure. Thus, in certain instances, it is preferable to place the call over the traditional public switched telephone network (PSTN).

In order to leverage the lower costs associated with Internet-based VOIP calls and maintain the guaranteed quality-of-service and reliability of the traditional PSTN calls, systems have been developed that enable customers to place and receive Internet-based calls (i.e., voice over Internet Protocol (VOIP) calls) as well as traditional public switched telephone network (PSTN) calls. An example of such a system is described in U.S. Pat. No. 6,404,764 to Jones et al. In this system, a network premises gateway provides an interface between the POTS telephones of the premises and the PSTN and Internet. When placing a call, the DTMF detection and call progress generator of the gateway detects an off-hook condition with a POTS telephone, receives a sequence of signals generated by the POTS telephone, and buffers this sequence. The gateway processes the sequence to detect a predetermined sequence that signify a VOIP-based call. Upon detection, the gateway enters VOIP mode whereby the call is placed over the Internet. If the predetermined sequence is not detected, the gateway enters a POTS mode whereby the buffered sequence is transmitted to the PSTN (i.e., redialed) such that call is placed over the PSTN. For VOIP calls, the gateway system provides analog-to-digital conversion functionality, digital-to-analog conversion functionality and protocol conversion functionality.

In these systems, circuitry is required to intercept and store the dialed number in addition to circuitry to seize the PSTN phone line and redial the number. Such circuitry adds unwanted complexity and costs to the systems. The complexities stem from the fact that the North American and European dialing conventions are highly irregular and frequently subject to change.

Moreover, it is imperative that in the advent of a power failure, the POTS telephones of the premises continue to operate. In such systems, because the POTS lines are intercepted, this can cause a problem during a power failure.

### SUMMARY OF THE INVENTION

It is therefore an object of the invention to provide an apparatus/methodology/system that routes voice calls over diverse networks (such as the PSTN, one or more Internet-based VOIP networks, and/or a WATS line) in a manner that does not require interception, storing and redialing the dialed number.

It is another object of the invention to provide such an apparatus/methodology/system that routes voice calls over diverse networks but which maintains a connection of analog telephone lines of the premises to the PSTN such that the POTS service provided by the PSTN enables the telephones to operate in a normal manner in the event of power failure.

It is a further object of the invention to provide such an apparatus/methodology/system that routes calls over the diverse networks in accordance with one or more routing tables.

It is also an object of the invention to provide configuration of such routing tables to minimize telephone usage costs that are attributable to calls placed over the diverse networks.

It is an additional object of the invention to provide flexible routing of an inbound voice call over a particular trunk to one or more lines in a premises.

It is still another object of the invention to provide such flexible routing in accordance with one or more routing tables and/or caller ID information that is part of the inbound voice call.

In accord with these objects, which will be discussed in detail below, a telephony system for a premises includes lines operably coupled to telephony devices, and trunks operably coupled to diverse networks (such as the PSTN network, one or Internet-based VOIP networks, and a WATS line). The lines may be directly connected to the telephony devices, or coupled thereto via a Public Branch Exchange (PBX) or key telephone system (KTS). A voice router includes a switch matrix operably coupled between the lines and trunks. In processing an outgoing voice call placed on a particular line, switch control means (e.g., a programmed microprocessor) controls the switch matrix to connect the particular line to at least two trunks (preferably in accordance with at least one routing table). The switch control means analyzes DTMF digit data (corresponding to DTMF digit tone(s) generated on the line) to determine a classification tag for the outgoing voice call, and disconnects (drops) the particular line from at least one trunk (which is preferably accomplished prior to completion of dialing) based upon the classification tag to enable the outgoing voice call to proceed over another one of the at least two trunks. An incoming voice call received over a particular trunk is connected to one or more lines by the switch matrix (preferably in accordance with at least one routing table).

It will be appreciated that this architecture does not intercept, store and redial the dialed number, thereby providing advanced routing functionality with lower costs.

According to one embodiment of the invention, one or more VOIP trunks couple the voice router to an external VOIP gateway. According to another embodiment of the invention, the voice router is integrated with VOIP gateway functionality within a common system housing. In such applications, the voice router may preferentially route local calls (as well as toll-free calls and emergency-911 calls) over the PSTN trunks, and preferentially route long distance calls (as well as international calls and site-to-site calls) over the VOIP trunks, to thereby minimize telephone usage costs that are attributable to calls placed over these networks.

Optionally, the voice router is adapted to directly connect the telephony devices in there idle state to the PSTN, thereby ensuring that all of the local signaling between the central office and the premise are preserved. This removes any conformance issues and greatly increases the reliability of the installation.

Additional objects and advantages of the invention will become apparent to those skilled in the art upon reference to the detailed description taken in conjunction with the provided figures.

### BRIEF DESCRIPTION OF THE DRAWINGS

FIG. 1 a simplified block diagram of a network environment that incorporates the voice routing mechanism in accordance with the present invention;

FIG. 2 is a functional block diagram illustrating the system architecture of an exemplary realization of the voice router of FIG. 1;

FIG. 3A illustrates the logical organization of an Inbound Routing Table utilized by the voice router of FIGS. 1 and 2 in accordance with the present invention.

FIGS. 3B and 3C illustrate exemplary Inbound Routing Tables for use by the voice router of FIGS. 1 and 2 in accordance with the present invention.

FIG. 4A illustrates the logical organization of an Outbound Routing Table utilized by the voice router of FIGS. 1 and 2 in accordance with the present invention.

FIGS. 4B, 4C, 4D and 4E illustrate exemplary Local Outbound Routing Tables and Long Distance Outbound Routing Tables for use by the voice router of FIGS. 1 and 2 in accordance with the present invention.

FIG. 5A illustrates the logical organization of a Trunk Ownership Data Structure utilized by the voice router of FIGS. 1 and 2 in accordance with the present invention.

FIG. 5B illustrates the logical organization of a Line Ownership Data Structure utilized by the voice router of FIGS. 1 and 2 in accordance with the present invention.

FIG. 6 is a flow chart describing the high level multi-threaded processing architecture that is part of the microprocessor-based voice routing routine of FIG. 2 in accordance with the present invention.

FIGS. 7A and 7B, in combination, is a flow chart that details the outgoing call processing operations carried out as part of the microprocessor-based voice routing routine of FIG. 2 in accordance with the present invention.

FIGS. 8A and 8B, in combination, is a flow chart that details the incoming call processing operations carried out as part of the microprocessor-based voice routing routine of FIG. 2 in accordance with the present invention.

FIG. 9 is a flow chart that details operations that update the connections of the switch matrix for idle trunks and lines; these operations are carried out as part of the microprocessor-based voice routing routine of FIG. 2 in accordance with the present invention.

FIG. 10 is a flow chart that details operations that monitors the quality of service (QOS) of the VOIP network and modifies the routing of VOIP calls based thereon; these operations are carried out as part of the microprocessor-based voice routing routine of FIG. 2 in accordance with the present invention.

FIG. 11 is a diagram illustrating the parallel routing operations of the voice router of FIGS. 1 and 2 in accordance with the present invention.

FIG. 12 is a simplified block diagram of a network environment that incorporates an alternate voice routing mechanism in accordance with the present invention;

FIG. 13 is a functional block diagram illustrating the system architecture of an exemplary realization of the voice router/gateway of FIG. 12;

FIG. 14 is a simplified block diagram of a network environment that incorporates a PBX and voice routing mechanism in accordance with the present invention; and

FIG. 15 is a functional block diagram illustrating the system architecture of an alternate embodiment of a voice routing mechanism in accordance with the present invention.

### DETAILED DESCRIPTION OF THE PREFERRED EMBODIMENTS

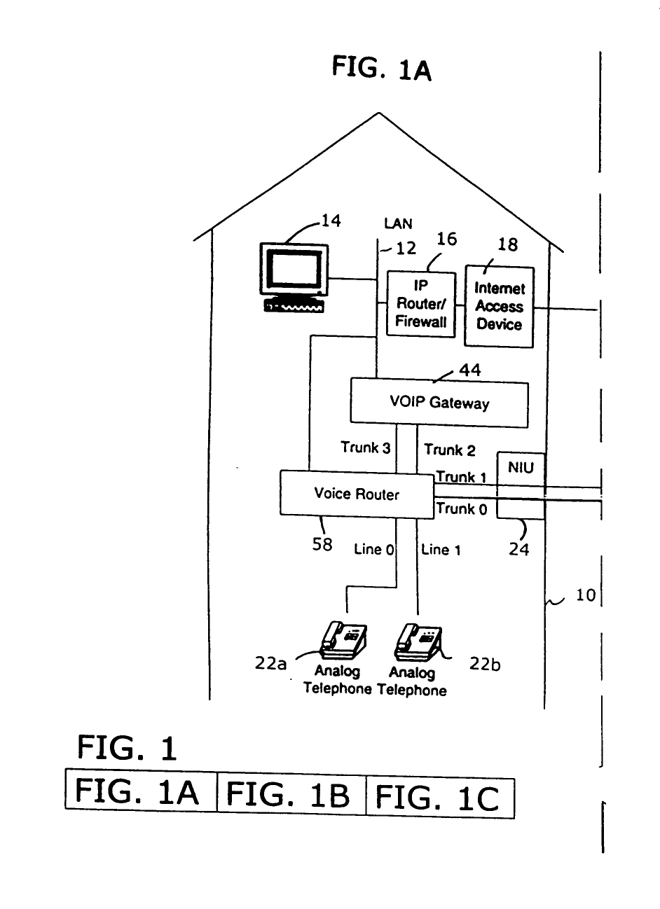

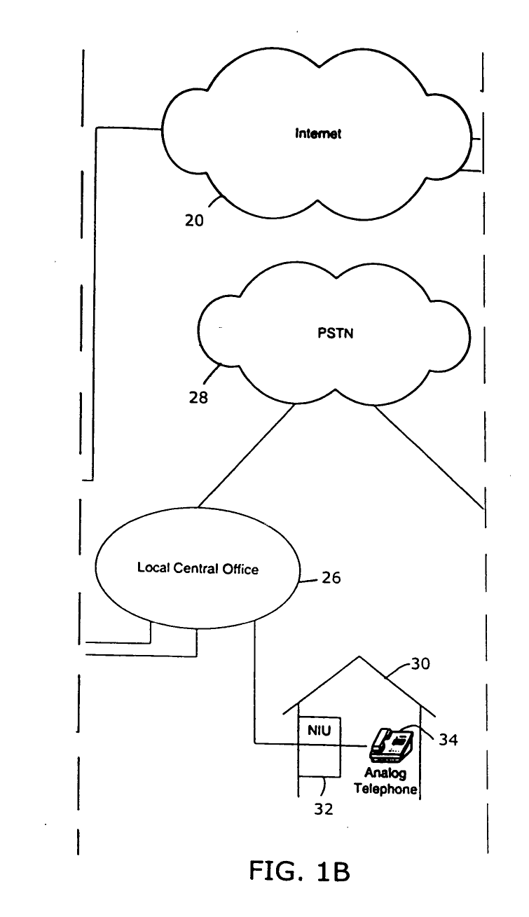

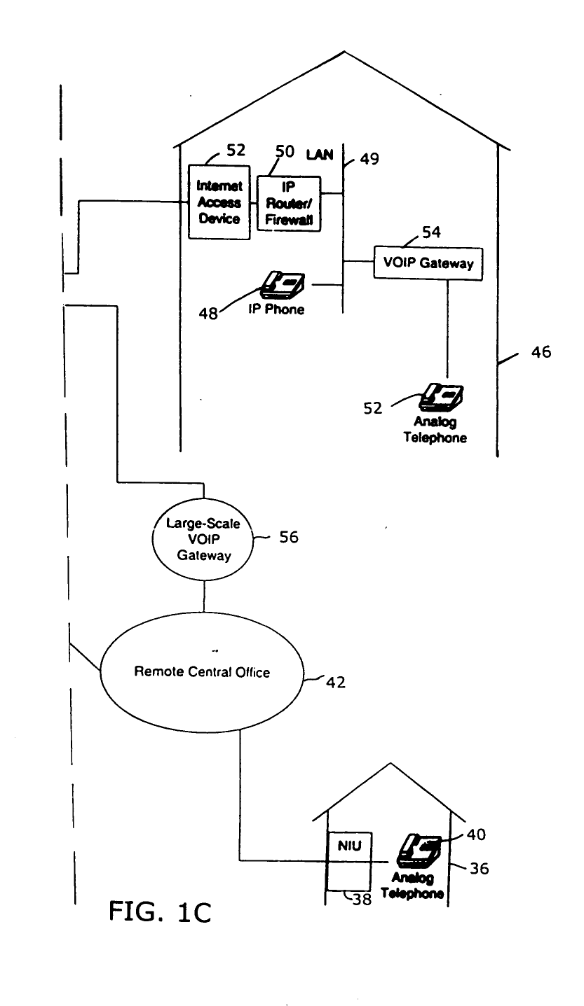

Turning to FIG. 1, there is shown a simplified block diagram of a network environment that incorporates the voice routing mechanism in accordance with the present invention. The environment includes a first premises 10, which may be a home, office building or office space within a larger office building. The premises 10 includes a LAN 12, which is preferably realized by an Ethernet-type switching network supporting a number of wired or wireless communications links, that interconnects a number of locally situated devices, such as one or more networked computers (one shown as 14), one or more networked printers (not shown), etc. The LAN 12 also includes an IP Router/Firewall device 16 and Internet Access Device 18 (e.g., cable modem, xDSL modem, etc) that cooperate to route IP packets between the devices operably coupled to the LAN 12 and the Internet 20.

The premises 10 is equipped with a number of analog telephony devices (such as analog telephones, fax machines or modems) that produce and/or receive analog signals typically carried over a POTS connection. In the illustrative embodiment shown, there are two analog telephones shown as 22a and 22b. A PSTN Network Interface Unit (NIU) 24 provides a connection point for one or more trunks (e.g., a copper twisted pair) that are operably coupled to the local central office 26 of the public-switched telephone network (PSTN) 28. The NIU 24, which is typically found on the outside of a residence in the United States, is the demarcation point between the telephone company's equipment and the subscriber's equipment. In the exemplary embodiment shown, the Network Interface Unit 24 provides a connection point to two copper twisted pair, trunk 0 and trunk 1. Traditional POTS-based calls are placed/received over the trunk(s) of the NIU 24 and PSTN. Such POTS-based calls can include local calls which connect to a local subscriber's premises equipment (shown as premises 30, NIU, 32 and analog telephone equipment 34), long distance calls which connect to a remote subscriber's premises equipment (shown as premises 36, NIU 38 and analog telephone 40 coupled to the remote central office 42 of the PSTN 28), toll-free calls, and/or emergency-911 calls. Note that a multi-channel T1 trunk may be used to couple the premises 10 to the local central office 26. In this configuration, a T1 channel service unit and channel bank may be used to provide a plurality of trunks that interface to the analog telephony devices of the premises 10 via the voice router 58.

The premises 10 is also equipped with a VOIP gateway 44 operably coupled to the LAN 12. The VOIP gateway 44 provides an interface between one or more analog telephony devices and the Internet-based VOIP network. The VOIP gateway 44 cooperates with the router/firewall 16 and Internet Access Device 18 to place/receive VOIP calls over the Internet-based VOIP network. Such VOIP calls can include long distance calls (or international calls or site-to-site) which connect to a remote subscriber's premises equipment. For example, a VOIP call can connect to subscriber's premises equipment at remote premises 46 as shown in FIG. 1. This equipment includes an IP phone 48 (connected via a LAN 49 to router/firewall device 50 and Internet Access Device 52), and an analog telephone 54 (connected via a VOIP gateway 54, LAN 49, router/firewall device 50 and Internet Access Device 52). The VOIP calls can also connect through parts of the PSTN. For example, a VOIP call can connect to subscriber's premises equipment at remote premises 36 through a VOIP gateway 56 (typically realized by a large-scale VOIP gateway device) operably coupled between the Internet and the PSTN. In a similar manner, the VOIP calls can connect to the local premises 30. Typically, it is preferable that such VOIP calls connect through the PSTN at a point near premises 30, 36 in order to minimize the costs associated with routing the call over the PSTN network.

With respect to outbound VOIP calls, the VOIP gateway 44 is responsible for IP-based call origination, analog-to-digital conversion of voice signals (and other analog signals) provided by the analog telephony device(s) coupled thereto, the creation of voice packets that represent such voice signals, and the forwarding of such voice packets to the Internet-based VOIP network via the router/firewall 16 and Internet Access Device 18. With respect to inbound VOIP calls, the VOIP gateway 44 is responsible for IP-based call detection, reception of voice packets from the to the Internet-based VOIP network via the router/firewall 16 and Internet Access Device 18, and digital-to-analog conversion of the voice signals represented by the packets for supply to the analog telephony device(s) coupled thereto. In addition, the VOIP gateway 44 may optionally include additional features, such as voice (analog and/or digital) compression, echo cancellation, silence suppression, and statistics gathering and reporting. Typically, each conversation (call) is a single IP session transported by a Real-time Transport Protocol (RTP) that runs over User Datagram Protocol (UDP) as is well known in the communication arts. In addition, signaling that sets up the call is typically provided by one or more protocols, such as H.323, Session Initiation Protocol (SIP) and/or Media Gateway Control Protocol (MGCP), which are well known in the communication arts.

In accordance with the present invention, a voice router 58 is provided that interfaces between the analog telephony devices (e.g., analog telephones 22a, 22b) and the trunk(s) operably connected to the PSTN via the NIU 24 to support the origination and reception of traditional POTS-based calls over such trunk(s). In addition, the voice router 58 interfaces between the telephony devices (e.g., analog telephones 22a, 22b) and the VOIP gateway 44 to support the origination and reception of VOIP calls over the Internet-based VOIP network. With respect to outbound calls placed from a given analog telephony device, the voice router 58 carries out an improved parallel dialing methodology that is triggered by the detection that the given analog telephony device has gone off-hook. This condition is indicated by the flow of line current that results from the device going off-hook. This line current is supplied to the voice router 58 over a line (e.g., a copper twisted pair) operably coupled between the given analog telephony device and the voice router 58. As part of the parallel dialing methodology, two or more trunks (preferably including a PSTN trunk and a VOIP trunk) are seized and one or more DTMF dial tones (which are generated by the given analog telephone device and supplied to the voice router 58 over the line therebetween) are simultaneously routed over the two or more seized trunks. Note that the DTMF tones are preferably routed over the two or more seized trunks without storage (and subsequent redialing) of such DTMF tones. These operations ensure compliance to the local signaling specifications of the central office, which is difficult to accomplish with a store and redial approach. The dial digit(s) corresponding to the DTMF tone(s) are analyzed by the voice router 58 (preferably utilizing a pattern matching operation as described herein) to select a preferred route classification corresponding thereto. In the preferred embodiment of the present invention, the preferred route classifications include a first value that indicates that the call should be preferably routed over the PSTN, and a second value that indicates that that the call should be preferably routed over the Internet-based VOIP network. In order to minimize costs to the subscriber, the first value is typically assigned to local calls (and possibly toll-free calls and emergency-911 calls) and the second value is typically assigned to long distance calls (and possibly international and site-to-site calls). In alternate embodiments of the present invention, the preferred route classifications can include values that indicate preferential routing over other networks (such as a WATS line or one of a plurality of Internet-based VOIP networks. After determining the preferred route classification, the unwanted seized trunk(s), which does not correspond to the preferred route classification, is released from the line of the given analog telephony device in order to terminate the dialing operations (and associated call signaling operations, if any) that occur over the unwanted trunk(s). The connection between the line of the given analog telephony device and the preferred trunk (that trunk which corresponds to the preferred route classification) is maintained such that the dialing operations (and associated call signaling operations) and subsequent communication (if the call is successful) occur over the preferred trunk.

The voice router 58 is also preferably configured to connect “idle” lines to “idle” trunks in accordance with an inbound call routing preferences tables (referred to herein as the Inbound Routing Table). This feature enables the voice router 58 to provide miscellaneous idle-time signaling (such as message waiting indications or billing information) from the “idle” trunks to the “idle” lines. Note that the protocols for such idle-time signaling vary widely over the PSTN. The automatic connection of “idle” lines to “idle” trunks provided by the voice router 58 affords an efficient mechanism to support such protocol variations.

In addition, the voice router 58 is preferably configured to operate in case of power failure such that the lines for one or more of the analog telephony devices (e.g., analog telephones 22a, 22b) are electrically connected to the PSTN trunk line(s) via the NIU 24. This enables the analog telephony devices to draw power from the POTS service (i.e., line current) provided by the PSTN trunk to ensure normal operation in the case of power failure.

Advantageously, the parallel routing operations carried out by the voice router 58 do not require local number storage, redial circuitry, and circuitry to determine that the dial is successful and thus provides a low cost solution. In addition, these operations ensure compliance to the local signaling specifications of the central office, which is difficult to accomplish with local number storage and redial circuitry. In addition, the omission of such circuitry enables improved fidelity of connection, which can enhance the speed at which modems, faxes and other analog telephony devices can connect over the voice router 58. Moreover, these operations are intrinsically more robust and facilitate pass-through routing in case of power failure whereby the lines for the analog telephony devices are electrically connected to the PSTN trunk line(s) via the NIU 24. Additionally, if the voice router 58 is used in a facility in which the speed at which calls can be placed is important (such as an outbound call center), these operations provide for minimal delay in placing the outbound call while maintaining the cost advantages of selective call routing over the PSTN and Internet-based VOIP network.

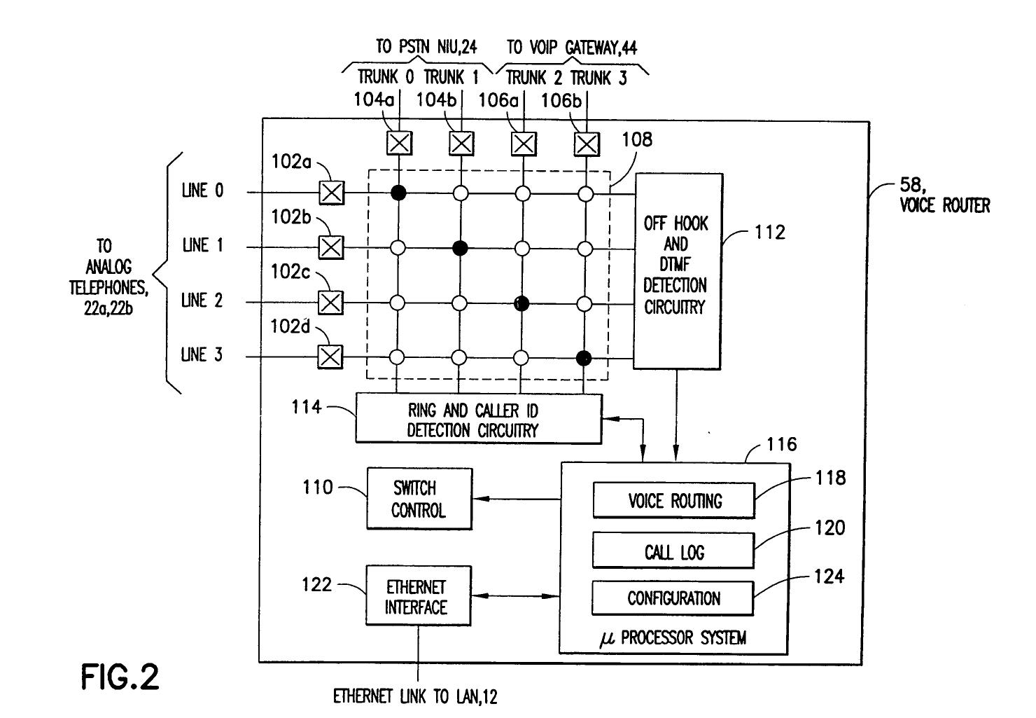

FIG. 2 is a functional block diagram illustrating the system architecture of an exemplary realization of the voice router 58 of FIG. 1. The voice router 58 includes four line ports (102a, 102b, 102c and 102d) that connect to corresponding lines (line 0, line 1, line 2 and line 3) that lead to the analog telephony devices (e.g., analog telephone 22a, analog telephone 22b, etc) of the premises 10. The voice router 58 also includes two PSTN trunk ports (104a, 104b) that connect to corresponding trunks (trunk 0, trunk 1) that lead to the NIU 24 of the premises 10, and two VOIP trunk ports (106a, 106b) that connect to corresponding trunks (trunk 2, trunk 3) that lead to VOIP gateway 44. Preferably, the ports 102a, 102b, 102c, 102d, 104a, 104b, 106a, 106b are realized by RJ-11 ports and the lines/trunks are realized by copper twisted pairs. A switch matrix 108 provides a switchable connection between one or more of the line ports (ports 102a-102d) and one or more of the trunk ports (104a, 104b, 106a, 106b) under control of switch control logic 110. The four line ports 102a-102d are coupled to line interface circuitry 112 which provides off-hook detection for the analog telephony devices coupled thereto in addition to detection of DTMF digits dialed by the analog telephony devices coupled thereto. Preferably, such off-hook detection is provided by an opt-coupler and digital filtering (which may be realized by a field programmable logic device, other programmable logic device, an ASIC, or other integrated circuit). In addition, the DTMF detection is preferably realized by an integrated circuit such as the DTMF Receiver 75T204 commercially available from TDK Semiconductor of Tustin, Calif. The four trunk ports 104a, 104b, 106a, 106b are coupled to trunk interface circuitry 114 which provides ring detection (e.g., detecting the ring voltage supplied over the trunk lines 0-4), and preferably Caller ID detection (which typically involves demodulating and decoding an FSK signal that occurs immediately after the first ring burst). Preferably, such ring detection and caller ID detection is provided by an integrated circuit, such as the MT88E43B commercially available from Zarlink Semiconductor of Ottowa, Canada.

Note that the local central office 26 (via the NIU 24) and the VOIP gateway 44 provide a Foreign Exchange Station (FXS) interface that delivers POTS service (including line current, ring voltage, dial tone) over the trunks 0-4 to the analog telephony devices coupled thereto via the switch matrix 108. The FXS interface also performs off-hook detection (i.e., detection of line current indicating that the trunk has been seized). In addition, the analog telephony devices (e.g., analog telephones 22a, 22b) include a Foreign Exchange Office (FXO) interface that receives POTS service (e.g., line current, ring voltage, dial tone) from the trunks 0-4 coupled thereto via the switch matrix 108.

In this configuration, an inbound PSTN call triggers the FXS interface of the local Central Office 26 to initiate a call by presenting a ring voltage over the PSTN trunk (trunk 0 or trunk 1). The switch matrix 108, which is configured to connect the PSTN trunk to one or more lines, passes the ring voltage over these line(s) to the attached analog telephony device(s). The FXO interface of the attached analog telephony device(s) detects the ring voltage (which triggers the phone to ring). When the telephone goes off-hook (i.e., “activated/picked up” by the user), line current flows through the loop coupled to the analog telephony device(s). This line current is detected by the FXS interface of the local Central Office 26. Similarly, an inbound VOIP call triggers the FXS interface of the VOIP gateway 44 to initiate a call by presenting a ring voltage over the VOIP trunk (trunk 2 or trunk 3). The switch matrix 108, which is configured to connect the VOIP trunk to one or more lines, passes the ring voltage over these line(s) to the attached analog telephony device(s). The FXO interface of the attached analog telephony device(s) detects the ring voltage (which triggers the phone to ring). When the telephone goes off-hook (i.e., “activated/picked up” by the user), line current flows through the loop coupled to the analog telephony device(s). This line current is detected by the FXS interface of the VOIP gateway 44.

Preferably, the switch matrix 108 is configured to operate in case of power failure such that the lines for one or more of the analog telephony devices (e.g., analog telephones 22a, 22b) are electrically connected to the PSTN trunk line(s) via the NIU 24. This feature can be realized by using normally-open relays for the interconnection means of the switch matrix 108 except on the diagonal where normally closed relays are employed. This arrangement ensures that in the absence of power, every trunk will be connected to its corresponding line. This feature enables the analog telephony devices to draw power from the line current provided by the PSTN trunk lines to ensure normal operation of these devices in the case of power failure.

The microprocessor system 116 includes a voice routing control routine 118 that carries out a parallel dialing methodology in accordance with the present invention. Note that the switch matrix 108 is configured in its idle state to connect idle line(s) to corresponding idle trunk(s) such that inbound/outbound calls can be placed and received over these connections. An outbound call is initiated when a given analog telephone device goes off-hook (i.e., “activated/picked up” by the user) and line current flows through the loop coupled to the given analog telephony device. This local loop can be terminated at the local Central Office 26 in the event that the “idle state” configuration connects the line for the given analog telephone device to a PSTN trunk. Alternatively, this local loop can be terminated at the VOIP Gateway 44 in the event that the “idle state” configuration connects the line for the given analog telephone device to a VOIP trunk. In either case, the line interface circuitry 112 of the voice router 58 detects this line current and provides an off-hook detect control signal to the microprocessor system 116 in response thereto. The routine 118 is triggered by this off-hook detect control signal. As part of the parallel dialing methodology, the routine 118 identifies two or more idle trunks, and seizes these two or more idle trunk(s) by controlling the switch control 110 to adjust the switch matrix 108 to connect the line port for the given analog telephone device to the trunks ports corresponding to these two or more idle trunk(s). Line current flows through these idle trunk(s) for detection by the FXS interface that terminates such trunk(s). In this manner, multiple trunks are connected to the line for the given analog telephony device and seized by the device. Preferably, these multiple trunks include a PSTN trunk and a VOIP trunk as will be described hereinafter.

Subsequent thereto, the FXO interface of the given analog telephone device dials the DTMF digits, which identify the destination to be called. One or more of these DTMF digits are simultaneously routed to the multiple trunks connected thereto by the switch matrix 108. In the event that a PSTN trunk is coupled to the given analog telephone device by the switch matrix 108, the FXS interface of the local Central Office 26 that terminates the PSTN trunk receives these DTMF digits. Based upon these DTMF digits, the local Central Office 26 performs signaling operations that sets up the voice circuit path through the PSTN for the call, and routes the call over the voice circuit path. Similarly, in the event that a VOIP trunk is coupled to the given analog telephone device by the switch matrix 108, the FXS interface of the VOIP gateway 44 that terminates the VOIP trunk receives these DTMF digits. Based upon these DTMF digits, the VOIP gateway 44 performs signaling operations that sets up the route through the Internet-based VOIP network, and routes the call over this path.

As the DTMF dial digit(s) pass through the voice router 108, the line interface circuitry 112 detects the DTMF dial digit(s) and supplies signals representing the DTMF dial digits to the routine 118. The routine 118 utilizes a pattern matching operation that analyzes the DTMF dial digit(s) and selects a preferred route classification that corresponds to the DTMF dial digits. The preferred route classifications preferably include a first value that indicates that the call should be preferably routed over the PSTN in addition to a second value that indicates that that the call should be preferably routed over the Internet-based VOIP network. In order to minimize costs to the subscriber, the first value is typically assigned to local calls (and possibly toll-free calls and emergency-911 calls) and the second value is typically assigned to long distance calls (and possibly international calls and site-to-site calls). After determining the preferred route classification, the routine 118 releases the unwanted trunk(s) (trunk(s) which do not correspond to the preferred route classification) by controlling the switch control 110 to adjust the switch matrix to decouple the trunk port for the unwanted trunk(s) from the line port of the given analog telephony device, thereby terminating the dialing operations (and associated call signaling operations, if any) that occur over the unwanted trunk(s). The routine 118 maintains the connection between the line port of the given analog telephony device and the trunk port for the preferred trunk (that trunk which corresponds to the preferred route classification) such that the dialing operations (and associated call signaling operations) and subsequent conversation (if the call is successful) occur over the preferred trunk. After the release of the unwanted trunk(s), the routine 118 preferably updates the idle connections of the switch matrix 108 in accordance with the preferences of a routing table as is discussed in detail below.

The microprocessor system 116 also maintains a call log 120 that stores information (such as origination number, destination number, start time, duration, and/or call type (e.g., PSTN or VOIP)) related to the inbound and/or outbound calls that are routed through the voice router 58. Such information is collected by the microprocessor system 116 as the calls are originated, received and terminated. Preferably, the call log is accessible to users over an Ethernet link to the LAN 12 as provided by an Ethernet interface 122. For example, access to the call log 120 can be provided by a network-based utility executing on the client machine 14 operably coupled to the LAN 12. Alternatively, the microprocessor system 116 can include an embedded web server that serves up the call log such that it can be accessed by users executing a standard web browser on the client machine 14.

The microprocessor system 116 also provides a configuration routine 124 that enables users to configure operational parameters (e.g., network parameters, routing tables, QOS parameters, feature enablement/disablement, etc). Preferably, the configuration routine is accessible to users over an Ethernet link to the LAN 12 as provided by the Ethernet interface 122. For example, access to the configuration routine 124 can be provided by a network-based utility executing on the client machine 14. Alternatively, the microprocessor system 116 can include an embedded web server that enables web-based configuration of the operational parameters by users executing a standard web browser on the client machine 14.

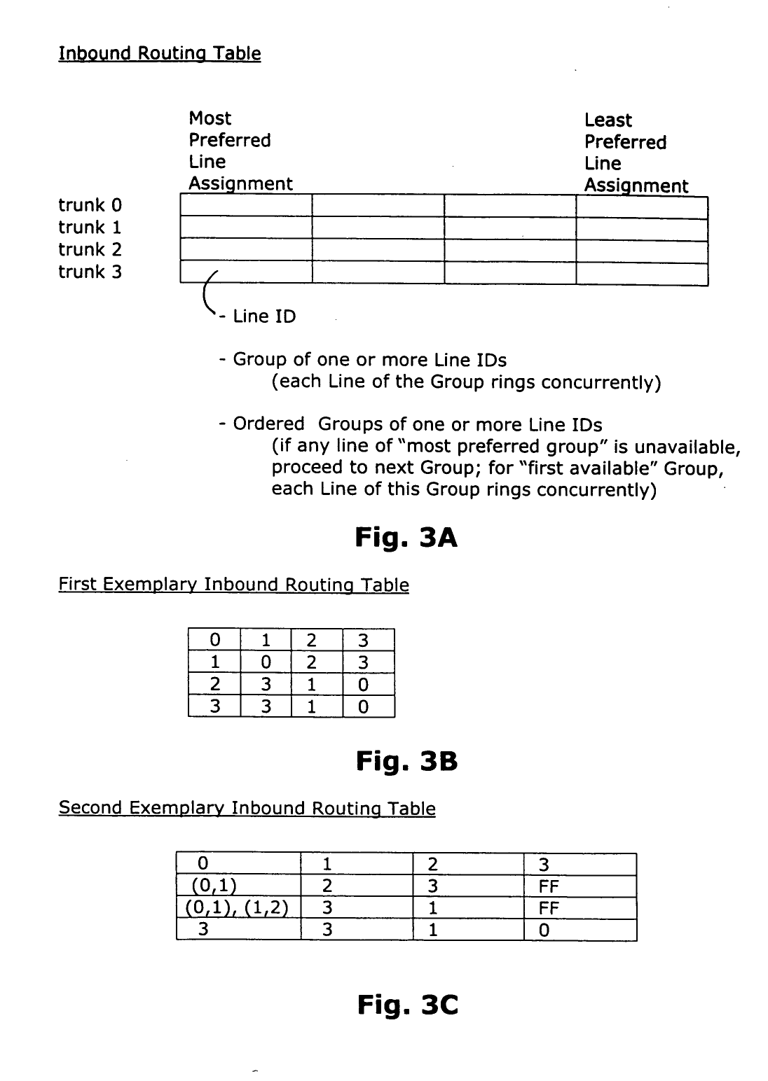

Turning now to FIGS. 3A-5B, there is shown exemplary data structures that may be used by the microprocessor-based voice routing routine 118 of the voice router 58 to realize the parallel routing methodology in accordance with the present invention. These data structures include an Inbound Routing Table, an Outbound Routing Table pertaining to each route classification (e.g., local and long distance), a Trunk Ownership byte pertaining to each trunk, and a Line Ownership byte pertaining to each line.

As shown in FIG. 3A, the Inbound Routing Table is logically organized as an array of rows and columns. Each row uniquely corresponds to one of the trunk ports of the voice router 58. The columns provide an ordered list of line assignments wherein the first column is most preferred and the last column is least preferred. The cells of the column include line ID values (or Groups of one or more Line ID values) that identify the lines that are assigned to the trunk ports corresponding to the rows of the cells. Note that in the case that the cells include Groups of Line ID values, each line of the Group may be connected to the assigned trunk port such that the lines of the group ring concurrently. Also note that each cell may include an ordered list of groups (from “most preferred” to least preferred). In this case, during incoming call processing on a particular trunk, if any line of the “most preferred” group is unavailable, the processing continues on to the next group. Upon detecting the first “available” group, each line of the Group is preferably connected to the assigned trunk port such that the lines of the group ring concurrently. Alternatively, the Line ID values over the second to last columns of the Inbound Routing Table can include a PCON (parallel connect) bit. When set, the Line corresponding to the Line ID (if available) is connected in parallel to the ringing inbound trunk. In this case, the search over the row of the table is concluded when an entry is found with out the PCON bit set.

FIG. 3B illustrates a first exemplary Inbound Routing Table. For the “most preferred line assignment” (column 1), line 0 is assigned to PSTN trunk 0, line 1 is assigned to PSTN trunk 1, line 2 is assigned to VOIP trunk 2, and line 3 is assigned to VOIP trunk 3. For the “least preferred trunk assignment” (column 4), line 3 is assigned to PSTN trunk 0, line 3 is assigned to PSTN trunk 1, line 0 is assigned to VOIP trunk 2, and line 0 is assigned to VOIP trunk 3.

FIG. 3C illustrates a second exemplary Inbound Routing Table. For the “most preferred line assignment” (column 1), line 0 is assigned to PSTN trunk 0, the group (line 0, line 1) is assigned to PSTN trunk 1, the ordered list of groups (line 0, line 1) and (line 1, line 2) is assigned to VOIP trunk 2, and line 3 is assigned to VOIP trunk 3. For the “least preferred trunk assignment” (column 4), line 3 is assigned to PSTN trunk 0, no trunk (FF) is assigned to PSTN trunk 1, no trunk (FF) is assigned to VOIP trunk 2, and line 0 is assigned to VOIP trunk 3. In processing an incoming call on PSTN trunk 1, it is preferred that the group (line 0, line 1) be connected to the trunk port for PSTN trunk 1 such that line 0 and line 1 ring concurrently. Similarly, in processing an incoming call on PSTN trunk 1, it is preferred that the group (line 0, line 1) be connected to the trunk port for PSTN trunk 1 such that line 0 and line 1 ring concurrently; however, if line 0 or line 1 is unavailable, it is preferred that the group (line 1, line 2) be connected to the trunk port for PSTN trunk 1 such that line 1 and line 2 ring concurrently.

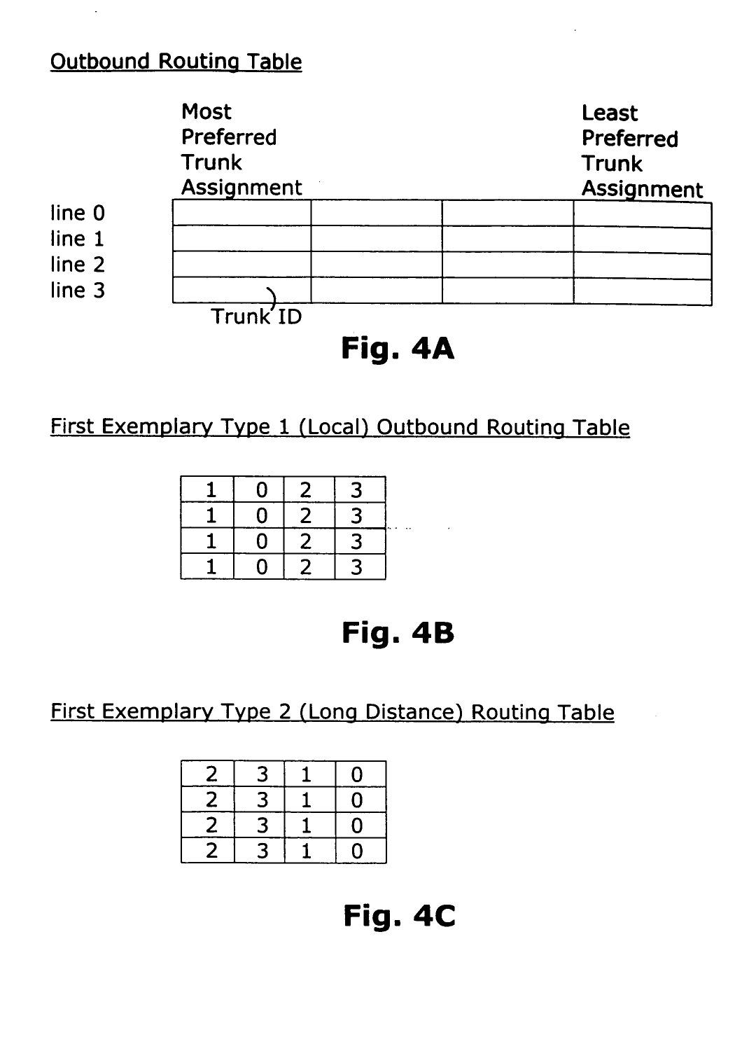

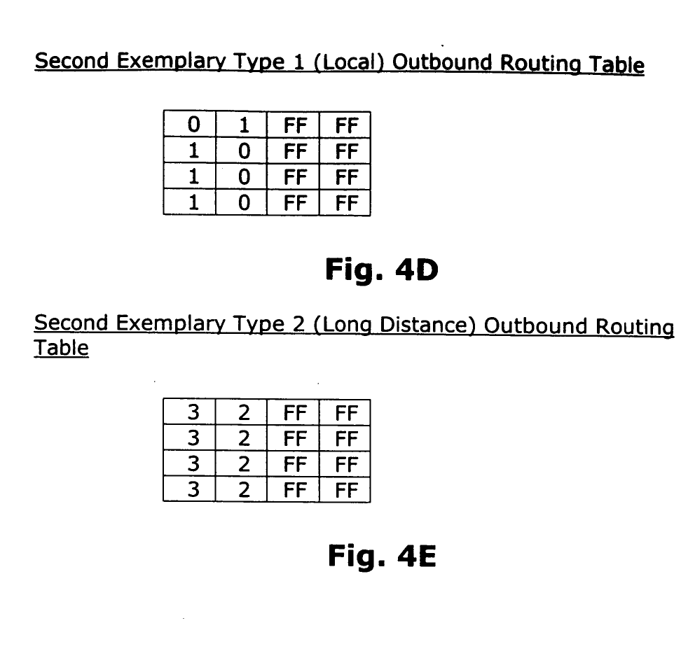

As shown in FIG. 4A, the Outbound Routing Table is logically organized as an array of rows and columns. Each row uniquely corresponds to one of the line ports of the voice router 58. The columns provide an ordered list of trunk assignments wherein the first column is most preferred and the last column is least preferred, and the cells of the column include trunk ID values that identify the trunk that are assigned to the line ports corresponding to the rows of the cells. FIGS. 4B through 4D illustrate exemplary Outbound Routing Tables. There are preferably different types of routing tables for the different network types of the system. In the example shown, there are two types of Outbound Routing Tables, one for “local calls” and another for “long distance calls”. In the exemplary “Local” Outbound Routing Table of FIG. 4B, for the “most preferred trunk assignment” (column 1), PSTN trunk 1 is assigned to lines 0-4. For the “least preferred trunk assignment” (column 4), VOIP trunk 3 is assigned to lines 0-4. This configuration biases the routing of outbound “local calls” to the PSTN trunk 1 as will become evident from the description below. In the exemplary “Long Distance” Outbound Routing Table of FIG. 4C, for the “most preferred trunk assignment” (column 1), VOIP trunk 2 is assigned to lines 0-4. For the “least preferred trunk assignment” (column 4), PSTN trunk 0 is assigned to lines 0-4. This biases the routing of outbound “long distance” calls to the VOIP trunk 2 as will become evident from the description below.

Note that the Outbound Routing Tables may be used to carry information that inhibits the routing of outbound calls over one or more trunks. For example, the “least preferred trunk assignment” (column 4) in the exemplary “Local” Outbound Routing Table of FIG. 4D utilizes a value FF to indicate no trunk is assigned to lines 0-4. This will inhibit the routing of outbound local calls over the VOIP trunks 2 and 3 in the event that the routing preferences in columns 1 and 2 cannot be satisfied (i.e., PSTN trunks 0 and 1 are busy servicing other calls). In another example, the “least preferred trunk assignment” (column 4) in the exemplary “Long Distance” Outbound Routing Table of FIG. 4E utilizes a value FF to indicate no trunk is assigned to lines 0-4. This will inhibit the routing of outbound long distance calls over the PSTN trunks 0 and 1 in the event that the routing preferences in columns 1 and 2 cannot be satisfied (i.e., VOIP trunks 3 and 2 are busy servicing other calls).

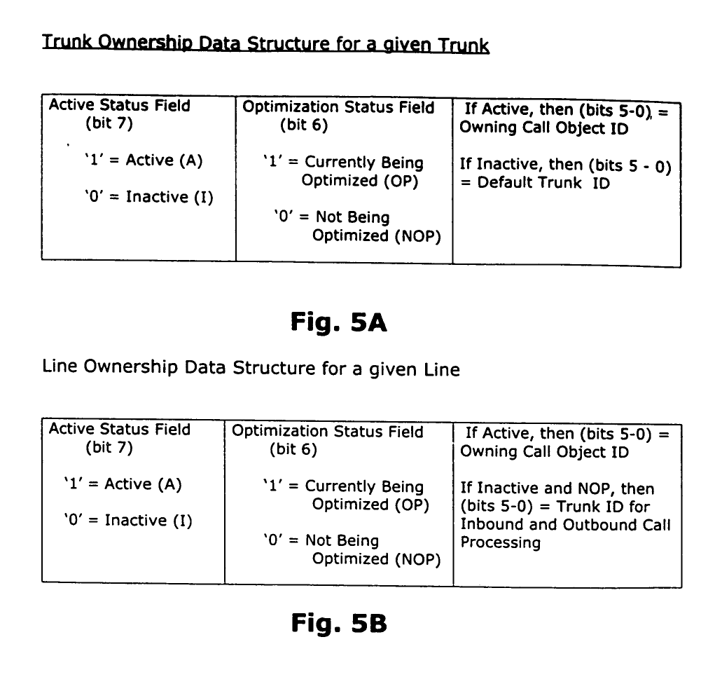

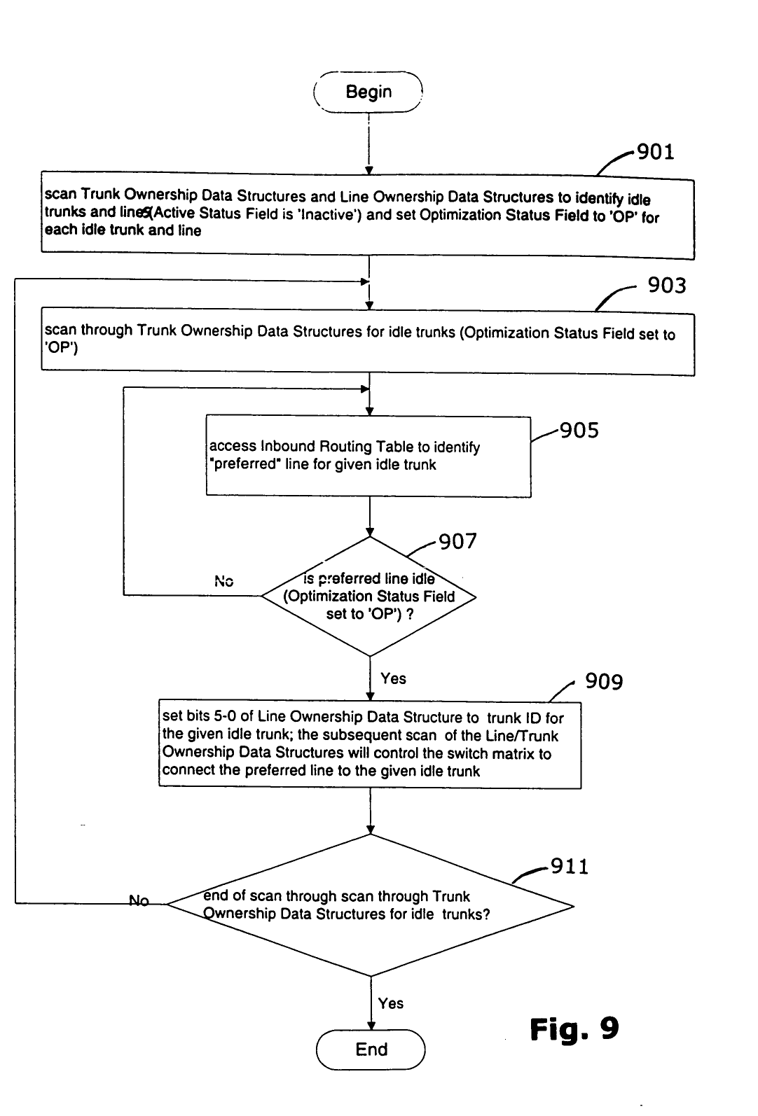

As shown in FIG. 5A, the Trunk Ownership byte pertaining to a given trunk includes an active status field (bit 7), an optimization status field (bit 6), and data bits 5-0. Thus there are four separate and distinct ownership bytes pertaining to the four trunks 0-4. In each Trunk Ownership byte, the active status field, when set to ‘active’/‘1’, indicates the given trunk is active (e.g., it is currently being used by an incoming or outgoing call). Conversely, the active status field, when set to ‘inactive’/‘0’, indicates the given trunk is inactive (e.g., it is not currently being used by an incoming or outgoing call). The optimization status field, when set to ‘OP’/‘1’, indicates the assignment of the given trunk is currently being optimized in conjunction with the matrix update operations described below with respect to FIG. 9. Conversely, the optimization status field, when set to ‘NOP’/‘0’, indicates the assignment of the given trunk is not currently being optimized in conjunction with the matrix update operations described below with respect to FIG. 9. If the given trunk is “active”, bits 5-0 contain a call object identifier for the call object that owns the trunk. If the given trunk is “inactive”, bits 5-0 contain a default trunk identifier (0 for the trunk ownership byte pertaining to trunk 0, 1 for the trunk ownership byte pertaining to trunk 1, 2 for the Trunk Ownership byte pertaining to trunk 2, and 3 for the trunk ownership byte pertaining to trunk 3).

As shown in FIG. 5B, the Line Ownership byte pertaining to a given line includes an active status field (bit 7), an optimization status field (bit 6), and data bits 5-0. Thus there are four separate and distinct ownership bytes pertaining to the four lines 0-3. In each Line Ownership byte, the active status field, when set to ‘active’/‘1’, indicates the given line is active (e.g., it is currently being used by an incoming or outgoing call). Conversely, the active status field, when set to ‘inactive’/‘0’, indicates the given line is inactive (e.g., it is not currently being used by an incoming or outgoing call). The optimization status field, when set to ‘OP’/‘1’, indicates the assignment of the given line is currently being optimized. Conversely, the optimization status field, when set to ‘NOP’/‘0’, indicates the assignment of the given line is not currently being optimized. If the given line is “active”, bits 5-0 contain a call object identifier for the call object that owns the line. If the given line is “inactive” and its assignment is currently not being optimized (bit 6 is ‘NOP’), bits 5-0 contain a “system” ownership assignment which is determined in conjunction with the matrix update operations described below with respect to FIG. 9. This ownership is used by the matrix scanning operations to make the matrix switch connections that best fit the preferences of the Inbound Routing Table.

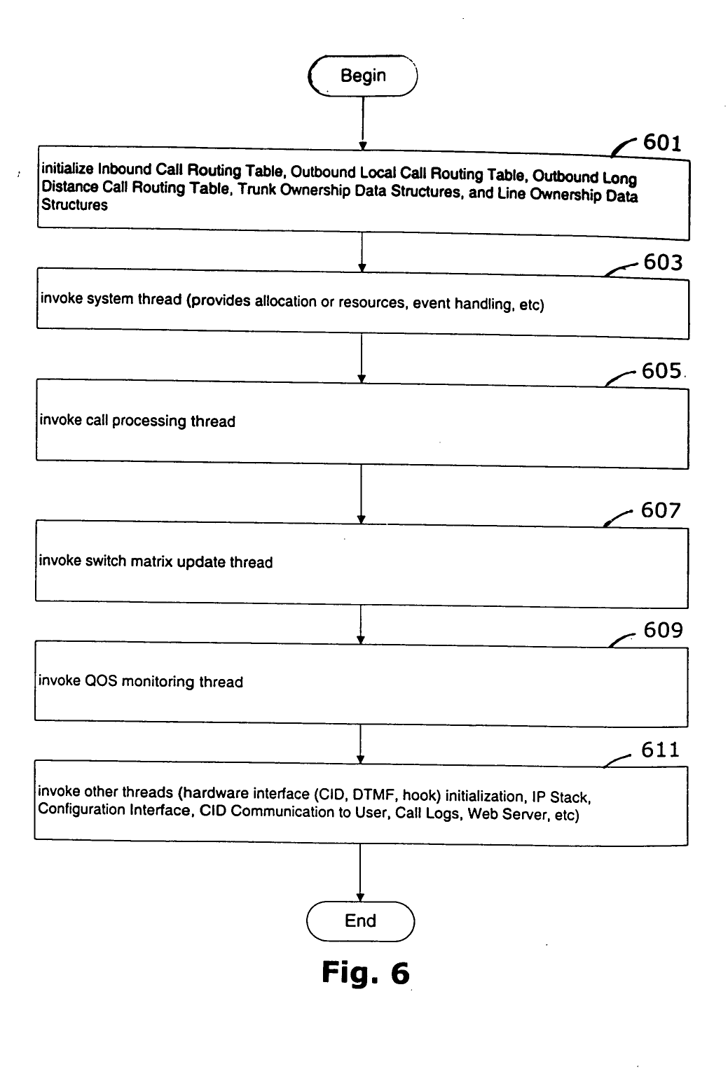

Turning now to FIGS. 6 through 10, there is shown flow charts illustrating an exemplary embodiment of operations carried out as part of the microprocessor-based voice routing routine 118. These operations utilize the data structures described above with respect to FIGS. 3A-5B to realize a parallel routing methodology in accordance with the present invention. These data structures include an Inbound Routing Table, an Outbound Routing Table pertaining to each route classification (e.g., local and long distance), a Trunk Ownership byte pertaining to each trunk, and a Line Ownership byte pertaining to each line.

FIG. 6 describes the high level multi-threaded processing architecture that is part of the microprocessor-based voice routing routine 118. It includes an initialization block 601 wherein the data structures (Inbound Routing Table, Outbound Routing Table pertaining to each route classification (e.g., local and long distance), Trunk Ownership byte pertaining to each trunk, and Line Ownership byte pertaining to each line)) are initialized. Preferably, the data structures are modified in accordance with the network-based configuration 124 executed by the microprocessor system 116 as set forth above, and stored in persistence storage (such as a flash memory module). During power up/system reset, the data structures are initialized by loading the stored data structures from persistence storage into allocated portions of the system memory of the microprocessor system 116. The high level processing also invokes a system thread that provides for allocation of system resources and event handling (block 603), a thread that performs call processing (block 605), , a thread that updates the switch matrix (block 607), and a thread that monitors the quality of service (QOS) of the Internet-based VOIP network and modifies the Outbound Routing Tables accordingly (block 609), and other threads that perform various system level functions (initialization of the hardware platform and an IP stack for IP packet processing) and that perform various application level functions (configuration, communication of caller-ID information to a user, Call Log access, Web Server, etc) (block 611).

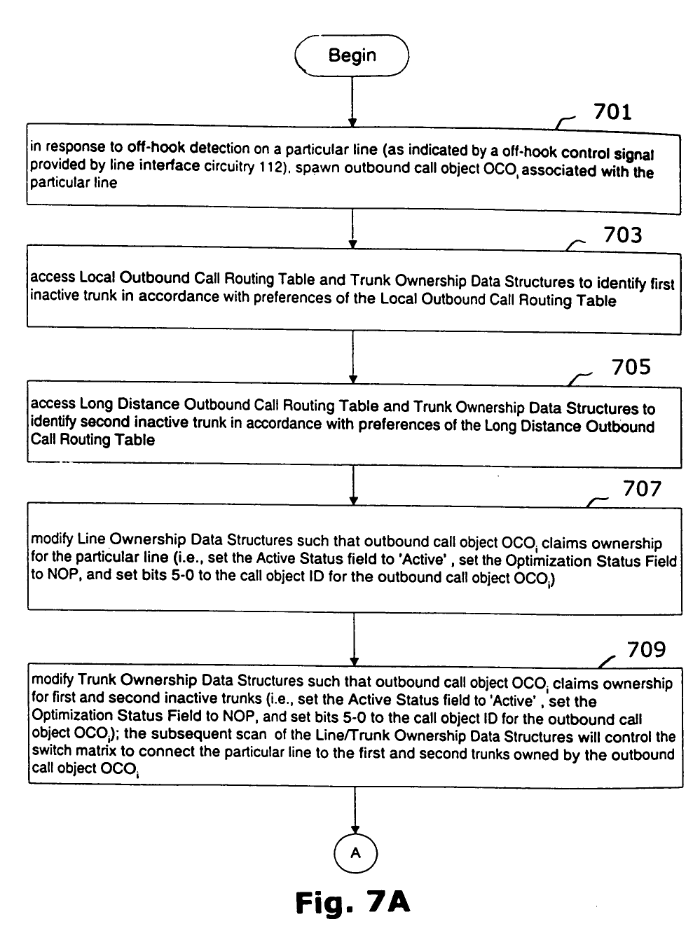

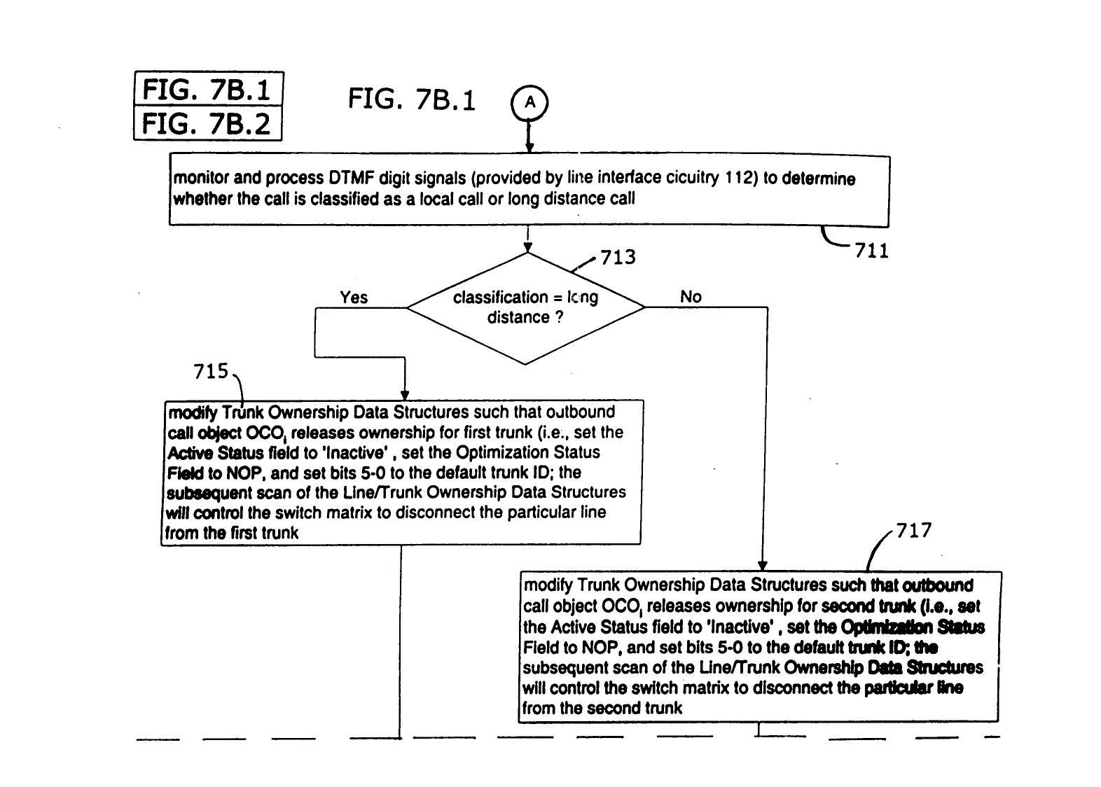

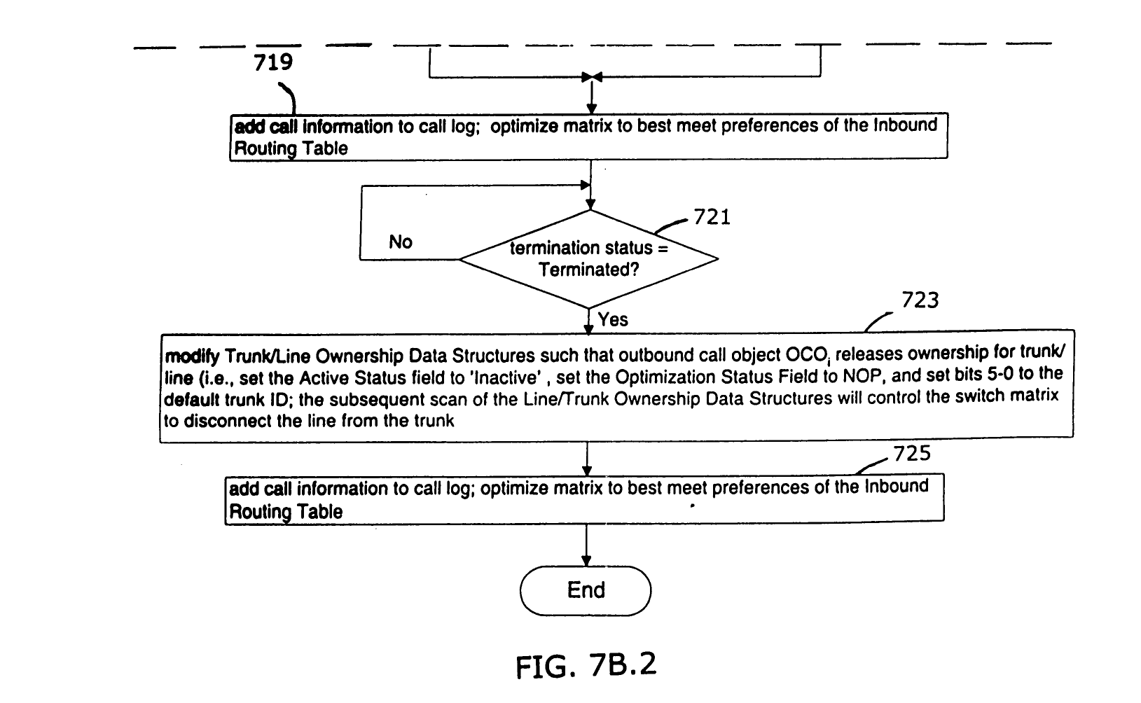

FIGS. 7A and 7B provide details of outgoing call processing operations carried out in block 605 of FIG. 6. The operations begin in block 701 whereby an outbound call object OCOᵢ that is associated with a particular line is spawned in response to an off-hook detect control signal provided by interface circuitry 112. The outbound call object OCOᵢ is tasked to handle an outbound call. It is the recipient of various events (e.g., hook signal, DTMF digit data, etc.) and follows a state machine to route, monitor and log the call as set forth in blocks 703 to 725.

In block 703, the “Local” Outbound Call Routing Table and Trunk Ownership bytes for the four trunks are accessed to identify a first inactive trunk (bit 7 is set to ‘0’) in accordance with the preferences of the “Local” Outbound Call Routing Table. Preferably, these operations involve sequencing through the cells of the row of the “Local” Outbound Call Routing Table that corresponds to the particular line. The cells are accessed from most preferred to least preferred. If the trunk identified by the cell is inactive (bit 7 is set to ‘0’), the trunk ID of the cell is used to identify the first inactive trunk. Note that a trunk ID of ‘FF’ indicates that no trunk is available for “local” routing.

In block 705, the “Long Distance” Outbound Call Routing Table and Trunk Ownership bytes for the four trunks are accessed to identify a second inactive trunk (bit 7 is set to ‘0’) in accordance with the preferences of the “Long Distance” Outbound Call Routing Table. Preferably, these operations involve sequencing through the cells of the row of the “Long Distance” Outbound Call Routing Table that corresponds to the particular line. The cells are accessed from most preferred to least preferred. If the trunk identified by the cell is inactive (bit 7 is set to ‘0’), the trunk ID of the cell is used to identify the second inactive trunk. Note that a trunk ID of ‘FF’ indicates that no trunk is available for “long distance” routing.

In block 707, the Line Ownership byte pertaining to the particular line is modified such that the outbound call object OCOᵢ claims ownership of the line. This is accomplished by setting the Active Status field (bit 7) to ‘active’, the Optimization Status field (bit 6) to ‘NOP’, and bits 5-0 to the call object identifier for the outbound call object OCOᵢ.

In block 709, the Trunk Ownership byte pertaining to the first and second inactive trunks identified in blocks 705 and 707 are modified such that the outbound call object OCOᵢ claims ownership of these two trunks. For the Trunk Ownership byte pertaining to the first inactive trunk, this is accomplished by setting the Active Status field (bit 7) to ‘active’, the Optimization Status field (bit 6) to ‘NOP’, and bits 5-0 to the call object identifier for the outbound call object OCOᵢ. Similar operations are performed with respect to the Trunk Ownership byte pertaining to the second inactive trunk. Note that the switch matrix update operations of block 607 periodically scan (for example, every 30 ms) the Line Ownership bytes and Trunk Ownership bytes to ascertain whether the bits 5-0 match (and the optimization status field is ‘NOP’). If so, switch matrix update operations cooperate with switch control 110 to update the switch matrix to connect the matching trunk and line. In this manner, the scan of the Line Ownership bytes and Trunk Ownership bytes that occurs subsequent to blocks 707 and 709 will control the switch matrix to connect the particular line to the first and second trunks owned by the outbound call object OCOᵢ. When the switch matrix connects the particular line to the first and second trunks owned by the outbound call object OCOᵢ, line current flows through these two trunks such that they are seized by the telephone device.

Note that in the event that there is no trunk available for “local” routing (i.e., the ID for the first inactive trunk in block 705 is FF), the modification of the Trunk Ownership byte for the first inactive trunk is omitted. In this case, the subsequent scan of the Line Ownership bytes and Trunk Ownership bytes will not control the switch matrix to connect the particular line to a ‘local’ trunk. Similarly, in the event that there is no trunk available for “long distance” routing (i.e., the ID for the second inactive trunk in block 707 is FF), the modification of the Trunk Ownership byte for the second inactive trunk is omitted. In this case, the subsequent scan of the Line Ownership bytes and Trunk Ownership bytes will not control the switch matrix to connect the particular line to a ‘long distance’ trunk.

In block 711, DTMF digits (which are detected by the line interface circuitry 112 signals in response to DTMF digit tones generated by the FXO interface of the analog telephone device on the particular line) are monitored and processed to determine whether the call is classified as a “local” call or a “long distance” call. Preferably, such operations utilize pattern matching operations with respect to the DTMF digits as they are generated to identify the correct classification of the call. In block 713, it is determined whether the class classification is long distance (or local).

If the classification is “long distance” in block 713, the operations continue to block 715 to modify the Trunk Ownership byte for the particular trunk such that outbound call object OCOᵢ releases ownership of the first trunk-that trunk identified in block 703. This is accomplished by setting the Active Status field (bit 7) to ‘inactive’, the Optimization Status field (bit 6) to ‘NOP’, and bits 5-0 to the default trunk identifier. In this manner, the scan of the Line Ownership bytes and Trunk Ownership bytes that occurs subsequent to block 715 will control the switch matrix to disconnect the particular line from the unwanted first trunk, thereby terminating the dialing operations (and associated call signaling operations, if any) that occur over the unwanted trunk. The operations of block 715 maintains the connection between the particular line and the preferred “long distance” trunk identified in block 705 such that the dialing operations (and associated call signaling operations) and subsequent conversation (if the call is successful) occur over the preferred trunk.

If the classification is “local” in block 713, the operations continue to block 717 to modify the Trunk Ownership byte for the particular trunk such that outbound call object OCOᵢ releases ownership of the second trunk-that trunk identified in block 705. This is accomplished by setting the Active Status field (bit 7) to ‘inactive’, the Optimization Status field (bit 6) to ‘NOP’, and bits 5-0 to the default trunk identifier. In this manner, the scan of the Line Ownership bytes and Trunk Ownership bytes that occurs subsequent to block 717 will control the switch matrix to disconnect the particular line from the unwanted second trunk, thereby terminating the dialing operations (and associated call signaling operations, if any) that occur over the unwanted trunk. The operations of block 717 maintain the connection between the particular line and the preferred “local” trunk identified in block 703 such that the dialing operations (and associated call signaling operations) and subsequent conversation (if the call is successful) occur over the preferred trunk.

After blocks 715 and 717, the operations continue to blocks 719 whereby information regarding the call (such as destination number and start time) are added to the call log 120. In addition, the connections of the switch matrix are updated to best meet the preferences of the Inbound Routing Table. These switch matrix update operations are set forth in detail in FIG. 9 and in the corresponding description below.

In block 721, the operations wait unit the call has been terminated and then continue to block 723 to modify the Trunk/Line Ownership bytes such that the outbound call object OCOᵢ releases ownership for the line/trunk seized for the call. This is accomplished by setting the Active Status field (bit 7) to ‘inactive’, the Optimization Status field (bit 6) to ‘NOP’, and bits 5-0 to the default trunk identifier. In this manner, the scan of the Line Ownership bytes and Trunk Ownership bytes that occurs subsequent to block 717 will control the switch matrix to disconnect the particular line from the trunk used for the call.

After block 723, the operations continue to block 725 whereby information regarding the call (such as end time and/or call duration) is added to the call log 120. In addition, the connections of the switch matrix are updated to best meet the preferences of the Inbound Routing Table. These switch matrix optimization operations are set forth in detail in FIG. 9 and in the corresponding description below. The call processing operations for the given call then end, and are typically repeated for subsequent outbound calls placed over the lines coupled to the voice router 58.

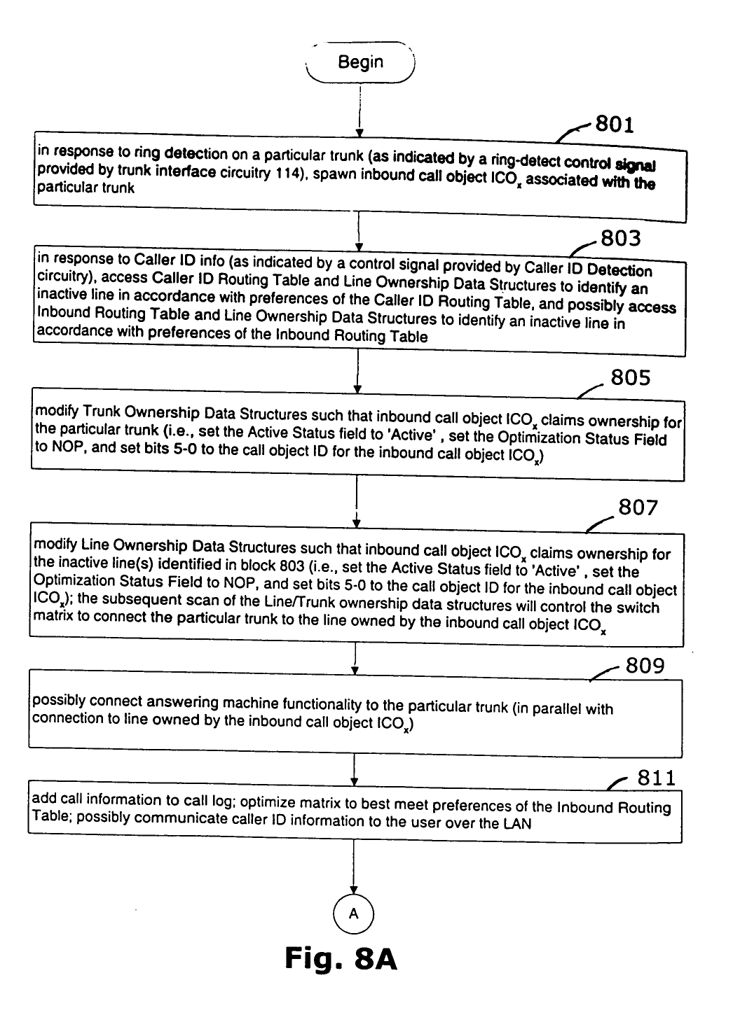

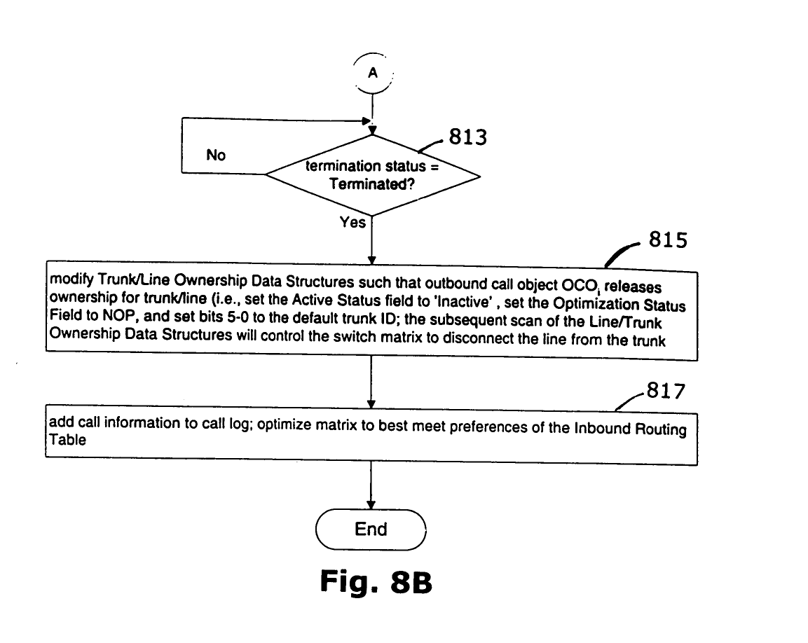

FIGS. 8A and 8B provide details of incoming call processing operations carried out in block 605 of FIG. 6. The operations begin in block 801 whereby an inbound call object ICOₓ that is associated with a particular trunk is spawned in response to a ring detection control signal provided by the trunk interface circuitry 114. The inbound call object ICOₓ is tasked to handle an inbound call and is the recipient of various events (e.g., ring detect signal, CID data etc.) and follows a state machine to route, monitor and log the call as set forth in blocks 803 to 817.

In block 803, Caller ID information (which is provided by the trunk interface circuitry 114) and the Line Ownership bytes are used to access a Caller ID Routing Table and identify an inactive line (bit 7 is set to ‘0’) in accordance with the preferences of the Caller ID Routing Table. The Caller ID Routing Table is similar in nature to the Inbound Call Routing Table yet assigns a preferred line (or group(s) of lines) to calls from a particular Caller ID. Preferably, these operations involve sequencing through the cell(s) of the row of the Caller ID Routing Table that corresponds to the particular caller ID. The cells are accessed from most preferred to least preferred. If the line(s) identified by the cell is inactive (bit 7 is set to ‘0’), the line ID(s) of the cell is used to identify the inactive line(s). If the Caller ID route processing fails (or is omitted), the operations of block 803 may utilize the Line Ownership Data Structures and Inbound Call Routing Table to identify an inactive line (or group of lines) (bit 7 is set to ‘0’) in accordance with the preferences of the Inbound Call Routing Table. Preferably, these operations involve sequencing through the cell(s) of the row of the Inbound Call Routing Table that corresponds to the particular trunk. The cells are accessed from most preferred to least preferred. If the line(s) identified by the cell is inactive (bit 7 is set to ‘0’), the line ID(s) of the cell is used to identify the inactive line(s).

Note that in the preferred embodiment of the present invention, the idle state of the switch matrix is updated to best meet the preferences of the Inbound Routing Table. In this configuration, the inbound call will automatically ring on the telephone device connected to the “idle state” line. Thus, if the Caller ID route processing identifies the same “idle state” line, the reconfiguration of the switch matrix in blocks 805 and 809 can be omitted.

In block 805, the Trunk Ownership byte pertaining to the particular trunk is modified such that the inbound call object ICOₓ claims ownership of the trunk. This is accomplished by setting the Active Status field (bit 7) to ‘active’, the Optimization Status field (bit 6) to ‘NOP’, and bits 5-0 to the call object identifier for the inbound call object ICOₓ.

In block 807, the Line Ownership byte pertaining to the inactive line(s) identified in block 803 is modified such that the inbound call object ICOₓ claims ownership of such line(s). This is accomplished by setting the Active Status field (bit 7) to ‘active’, the Optimization Status field (bit 6) to ‘NOP’, and bits 5-0 to the call object identifier for the inbound call object ICOₓ. In this manner, the scan of the Line Ownership Bytes and Trunk Ownership Bytes that occurs subsequent to blocks 805 and 807 will control the switch matrix to connect the particular trunk to the line(s) owned by the inbound call object ICOₓ. When the switch matrix connects the particular trunk to the line(s) owned by the inbound call object ICOₓ, line current flows through these line(s) such that the line(s) and particular trunk are seized by the telephone device.

In block 809, the operations may connect answering machine functionality to the particular trunk in parallel with the connection to the line(s) owned by the inbound call object. This may be accomplished by connecting an answering machine device to one of the lines (e.g., line 4) and configuring the Inbound Routing Table to connect the answering machine line (line 4) to the inbound trunk in parallel to the connection of the inbound trunk to one or more analog telephone lines (e.g., lines 1 and 2). Alternatively, answering machine functionality can be integrated into the routing device 58 itself. In this case, the voice messages stored therein may be stored in digital form and made accessible to the user(s) via dialing predetermined DTMF digits over one of the lines (and possibly made accessible over the LAN 12).

In block 811, information regarding the call (such as origination number and start time) is added to the call log 120. In addition, the connections of the switch matrix are updated to best meet the preferences of the Inbound Routing Table. These switch matrix update operations are set forth in detail in FIG. 9 and in the corresponding description below. In addition, the processing may communicate the caller ID information, if any, to a user over the LAN 12. This may be accomplished by a web-based utility, executing on a client machine, that receives events from the voice router 58 over the LAN (preferably using UDP or TCP). The caller ID information is communicated as an event from the voice router (preferably using an IP multicast packet containing the detail of the caller ID information). Alternatively, a web-based utility (for example, a JAVA applet) polls the voice router 58 periodically and expects a short return (i.e. new data/no new data). If there is new data, then the utility performs an HTTP GET to retrieve the Caller ID information the voice router 58.

In block 813, the operations wait until the call has been terminated and then continue to block 815 to modify the Trunk/Line Ownership bytes such that the inbound call object ICOₓ releases ownership for the line/trunk seized for the call. This is accomplished by setting the Active Status field (bit 7) to ‘inactive’, the Optimization Status field (bit 6) to ‘NOP’, and bits 5-0 to the default trunk identifier. In this manner, the scan of the Line Ownership bytes and Trunk Ownership bytes that occurs subsequent to block 813 will control the switch matrix to disconnect the particular trunk from the line used for the call.

After block 815, the operations continue to block 817 whereby information regarding the call (such as end time and/or call duration) is added to the call log 120. In addition, the connections of the switch matrix are updated to best meet the preferences of the Inbound Routing Table. These switch matrix update operations are set forth in detail in FIG. 9 and in the corresponding description below. The call processing operations for the given call then end, and are typically repeated for subsequent inbound calls placed over the trunks coupled to the voice router 58.

FIG. 9 provides details of operations that update the connections of the switch matrix for idle trunks and lines to best meet the preferences of the Inbound Routing Table. Preferably, these operations are performed whenever the configuration of the switch matrix is changed. The operations begin in block 901 whereby the Trunk Ownership bytes and the Line Ownership bytes are scanned to identify idle trunks and lines (i.e., whose Active Status Field (bit 7) is ‘Inactive’), and, for each idle trunk and line, setting the Optimization Status field (bit 6) to ‘OP’.

In block 903, a preference scan is made through the Trunk Ownership bytes to identify idle trunks whose Optimization Status Field is set to ‘OP’. For each one of these trunks, the operations of blocks 905 through 911 are performed.

In block 905, the Inbound Routing Table is accessed to identify the “preferred” line for the given trunk. This is accomplished by sequencing through the preference levels for the given trunk. If the line at the preference level is available, then it is the “preferred” line; otherwise move on to the next preference level.

In block 907, the Line Ownership byte for the “preferred” line is accessed to determine if its Optimization Status Field is set to ‘OP’. If not, the operations return to block 905 to identify the next “preferred” line in accordance with the preferences of the Inbound Routing Table. If, in block 907, the Line Ownership byte for the “preferred” line includes an Optimization Status Field set to ‘NOP’, the operations continue to block 909.

In block 909, bits 5-0 of the Line Ownership byte for the “preferred” line is set to the trunk ID for the given trunk. In this manner, the scan of the Line Ownership bytes and Trunk Ownership bytes that occurs subsequent to block 909 will control the switch matrix to connect the “preferred” line to the given trunk.

In block 911, it is determined whether the scan over the trunks whose Optimization Status Field is set to ‘OP’ is complete. If not, the operation returns to block 903 to perform the operations of blocks 905 through 909 for another idle trunk. If the scan is complete, the operation ends. In this manner, the connections of the switch matrix for the idle trunks and lines are updated for inbound call processing.

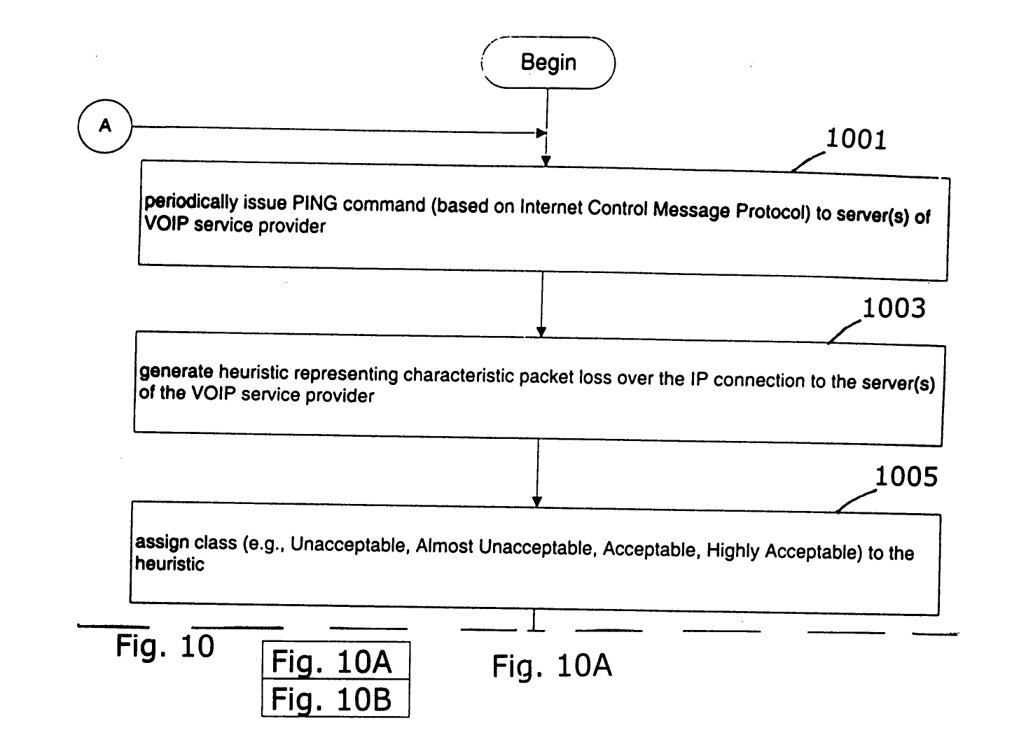

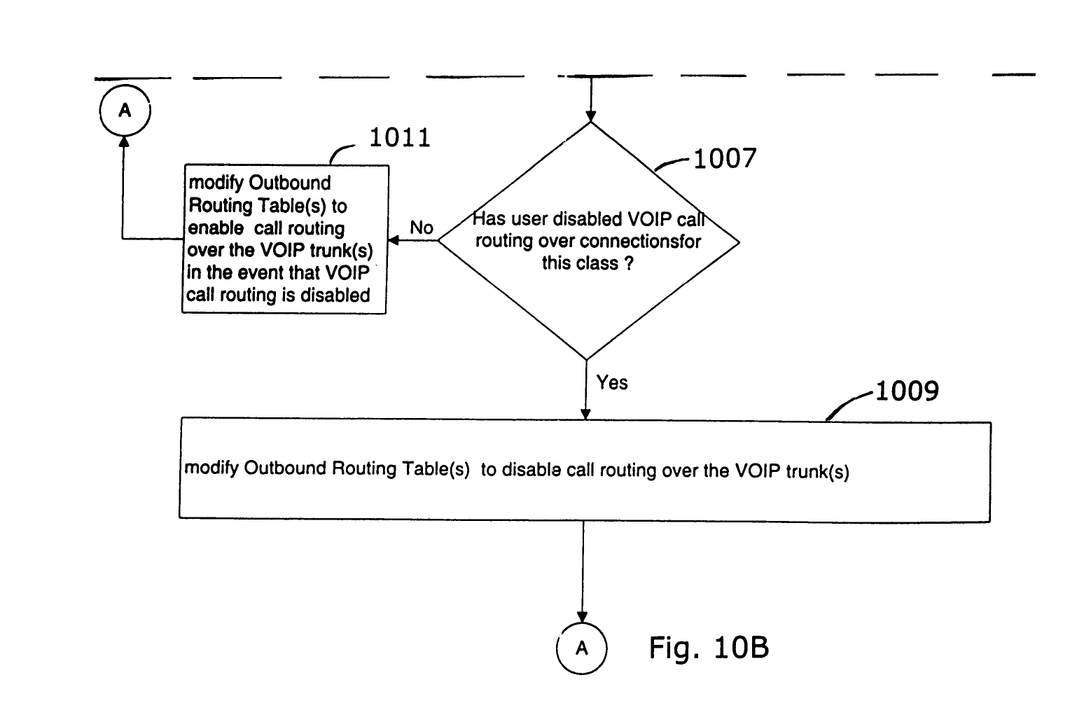

FIG. 10 provides the details of operations that monitor the quality of service (QOS) of the Internet-based VOIP network and modify the Outbound Routing Tables accordingly (block 609 of FIG. 6). The operations begin in block 1001 whereby the voice router 58 periodically issues a PING command to one or more servers of the Internet-based VOIP network. Such servers are typically maintained by a VOIP service provider that is responsible for routing VOIP calls from the voice router 58 through the Internet-based VOIP network. The PING command, which is based on the Internet Control Message Protocol, provides a measurement of the round trip time for an IP packet communicated over the LAN/Internet to the VOIP server and back to the voice router 58, and also provides a percentage of packets lost during this round trip. In block 1003, the packet lost percentage returned by the PING commands are used to generate a heuristic that represents the characteristic packet loss over the IP connection to these servers. In block 1005, the heuristic is assigned to a class (for example, Unacceptable, Almost Unacceptable, Acceptable, Highly Acceptable). In block 1007, it is determined whether the user has disabled routing over connections for the class identified in block 1005. If so the operations continue to block 1009 whereby the Outbound Routing Table(s) are modified to disable VOIP-based call routing over the VOIP trunks coupled to the voice router 58 and the operations return to block 1001 to continue monitoring the QOS of the VOIP network.

If, in block 1007, it is determined that the user has not disabled routing over connections for the class corresponding to the heuristic, the operations continue to block 1011. In block 1011, the Outbound Routing Table(s) are modified, if need be, to enable VOIP-based call routing over the VOIP trunks coupled to the voice router 58, and the operations return to block 1001 to continue monitoring the QOS of the VOIP network.

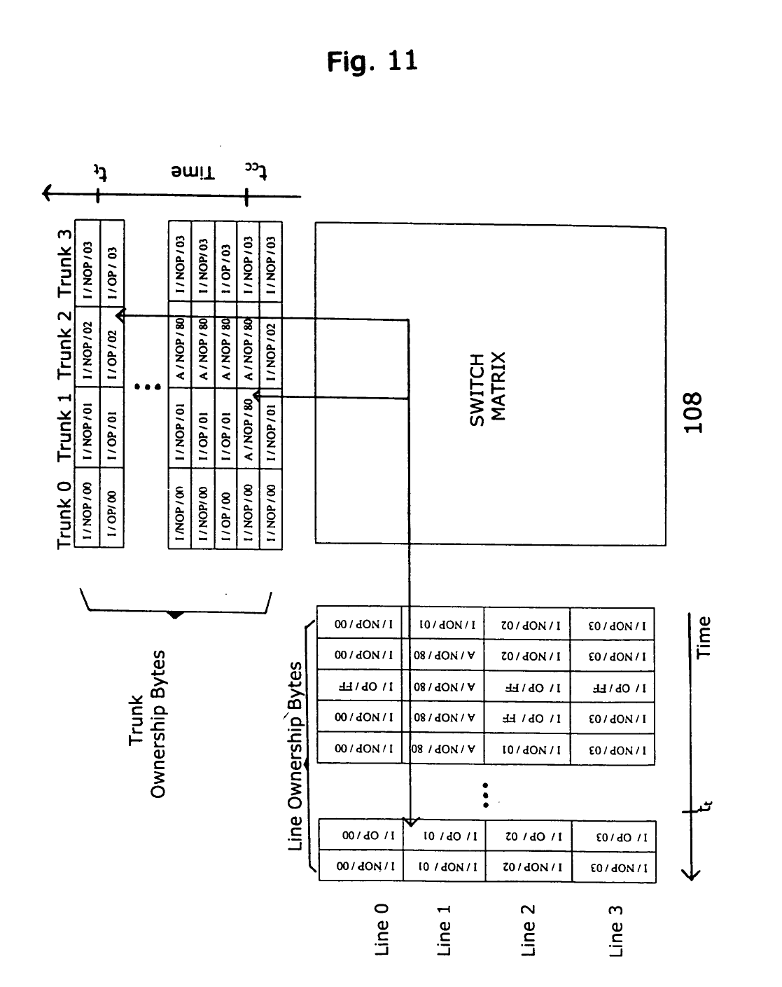

FIG. 11 illustrates the parallel routing operations of the voice router 58 of FIGS. 1 and 2 in accordance with the present invention. The outbound call is initiated over line 1. The outbound call processing operations described above with respect to FIGS. 7A and 7B manipulate the Trunk Ownership bytes and Line Ownership bytes to initially connect the call over PSTN trunk 1 and VOIP trunk 2 (as indicated pictorially by the two arrows). At a point in the processing (labeled t_{cc}), the operations identify the preferred trunk as VOIP trunk 2 (for example, it is a long distance call) and disconnect the unwanted PSTN trunk 1 (as indicated by the end point of the arrow on trunk 1). After this disconnection, the connections of idle trunks and lines are updated in accordance with the preferences of the Local Inbound Routing Table as described above with respect to FIG. 9. Such update operations are also performed after the outbound call is terminated at time t, (as indicated by the end point of the arrows on line 1 and trunk 2).

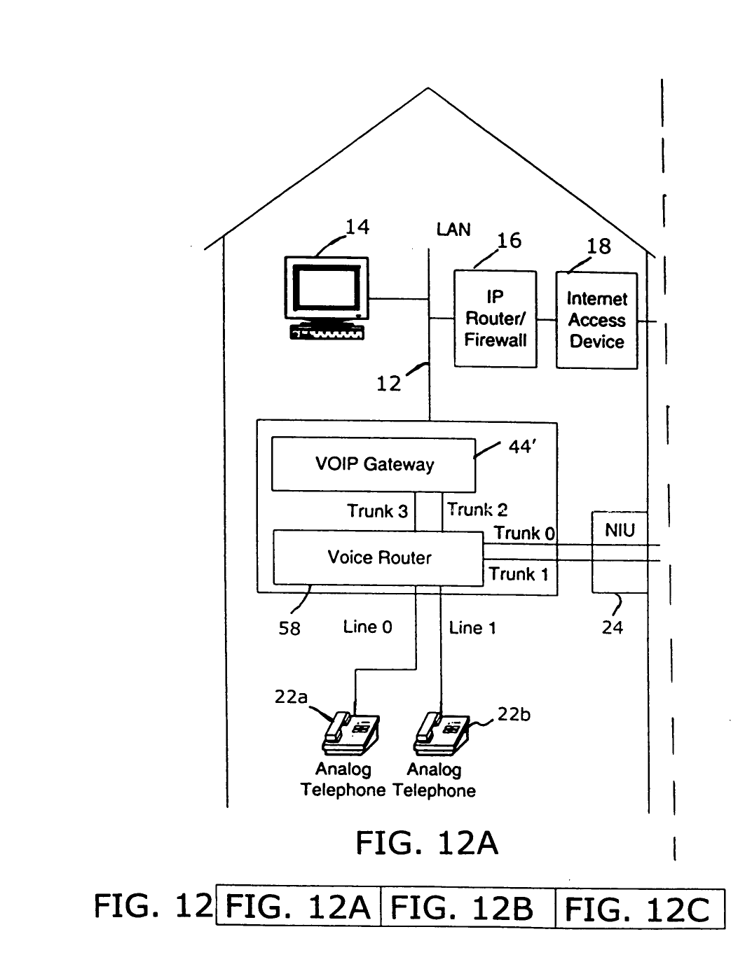

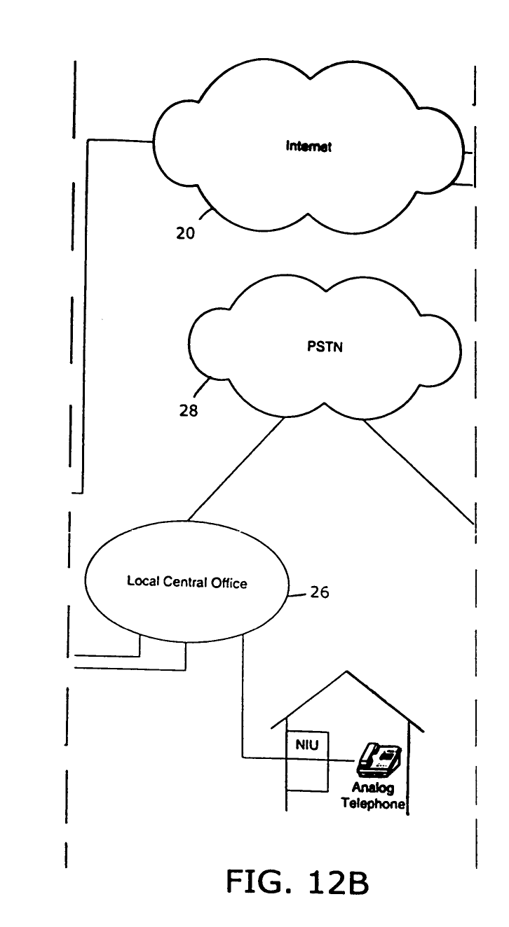

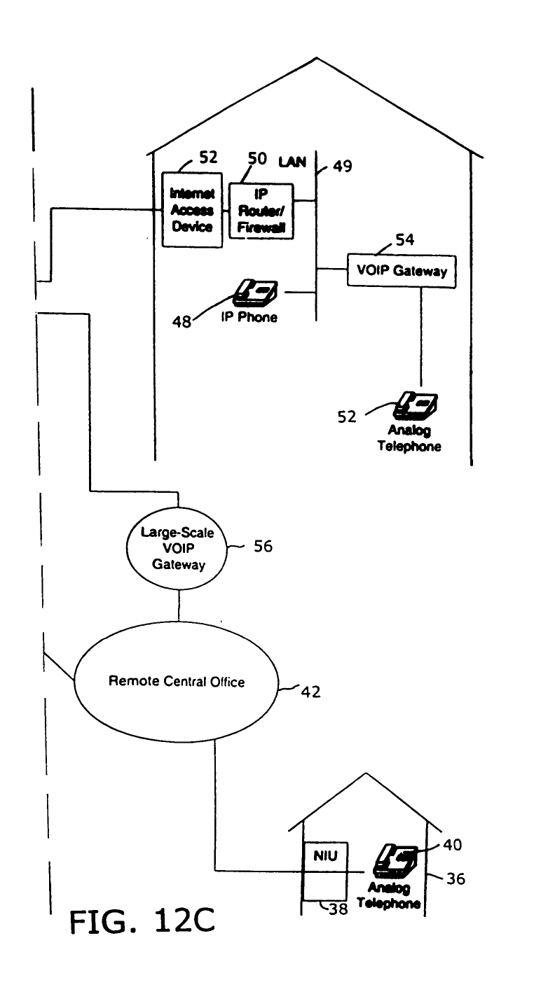

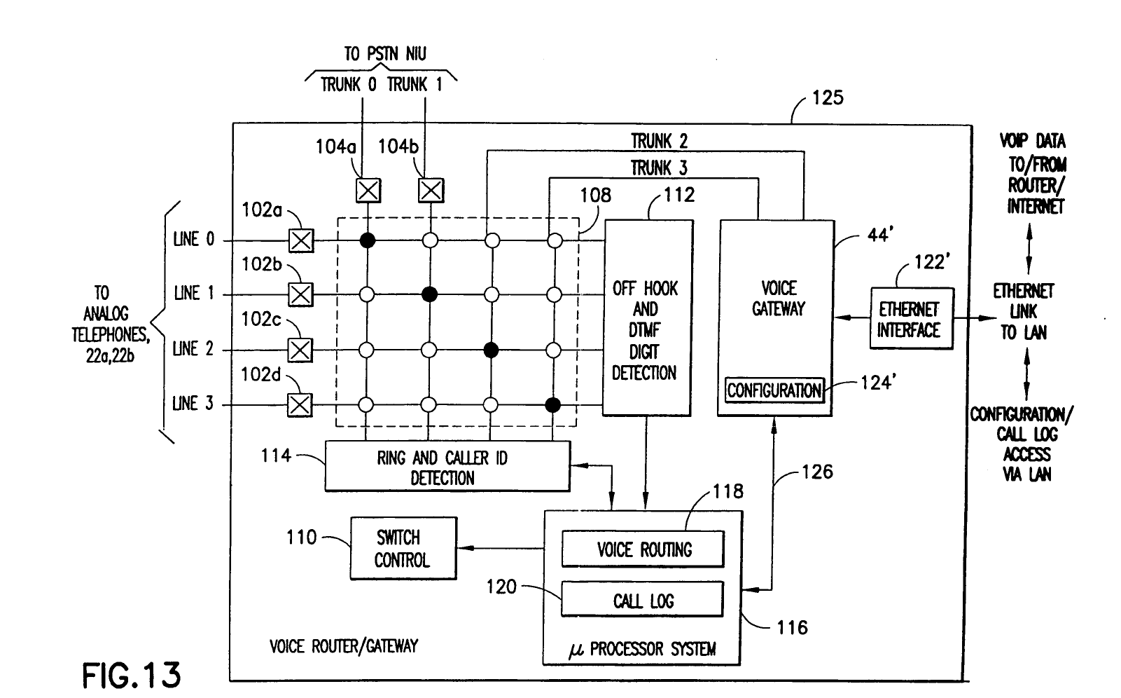

FIG. 12 and 13 illustrate an alternate embodiment of the present invention wherein the voice router functionality is integrated with voice gateway functionality in a common system housing 125. In this embodiment, the majority of the components of the system operate as described above with respect to FIGS. 1 through 11. However, the voice gateway functionality 44′ and the microprocessor system 116 share a common Ethernet interface module 122′, which is preferably made accessible to the microprocessor system 116 by a data path 126 between the microprocessor system 116 and the voice gateway 44′. Note that the voice routing routine 118 may be integrated into a microprocessor system that is part of the voice routing functionality 44′. Moreover, the network-enabled configuration module of the combined device is preferably integrated with the configuration module 124′ of the voice gateway 44′.

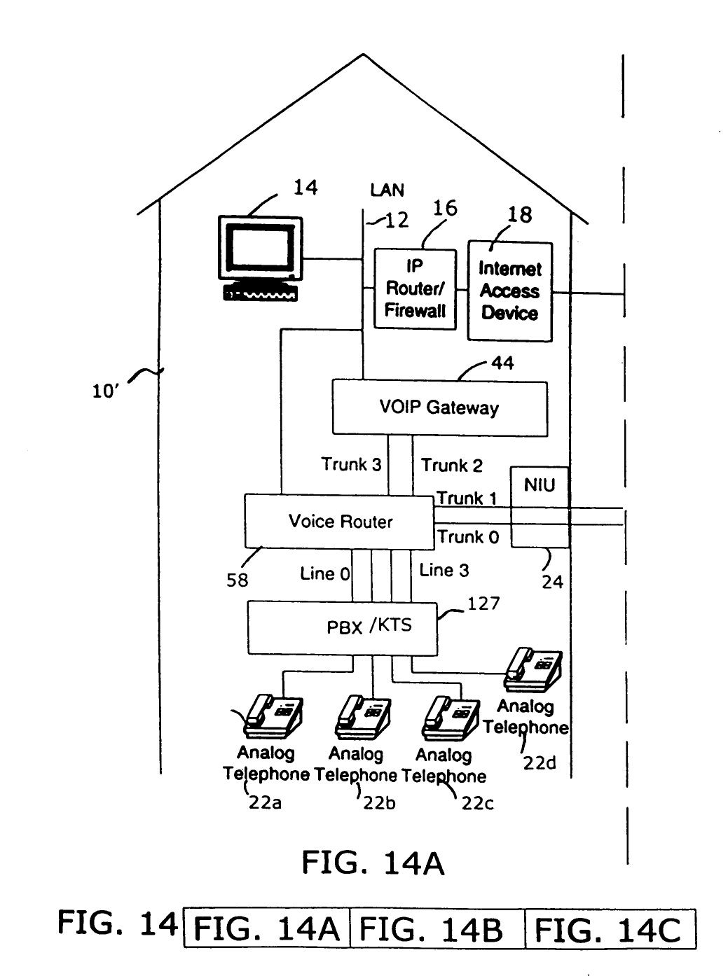

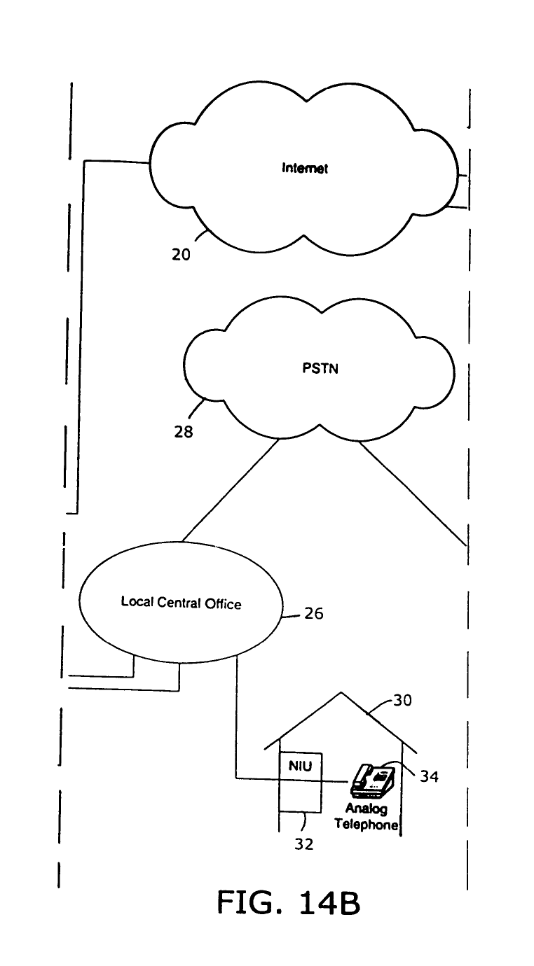

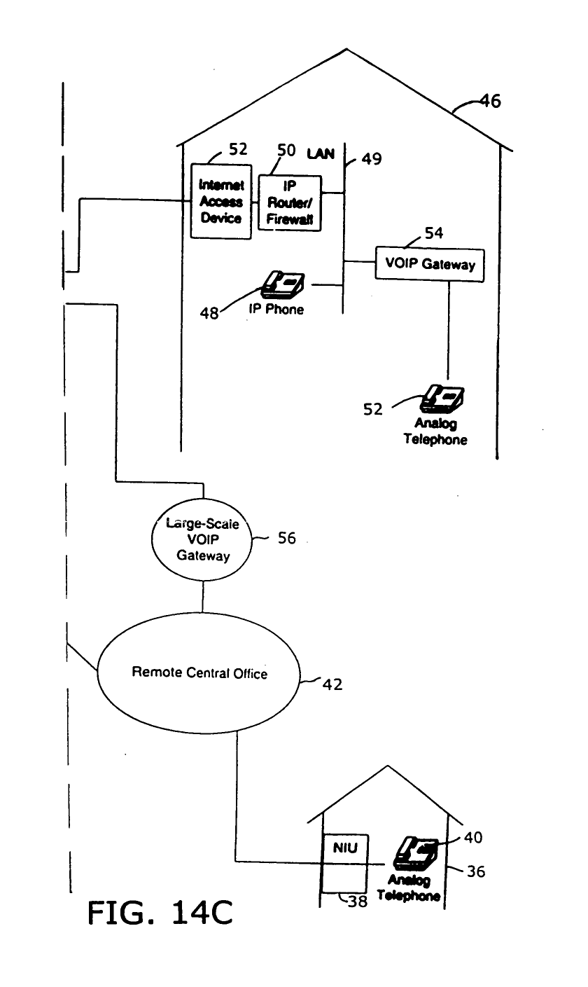

FIG. 14 illustrates an alternate embodiment of the present invention wherein the voice router 58 is operably disposed between a conventional private branch exchange (PBX) or key telephone system (KTS) 127 and the VOIP Gateway 44 and PSTN NIU 24. The PBX is a customer premises telephone switching system that performs incoming call termination and outgoing line selection such that the analog telephony devices (e.g., analog telephones 22a, 22b, 22c, 22d) of the premises share the use of the telecommunication lines (lines 0-3) coupled thereto and connected to the PSTN-based trunks and VOIP-based trunks via the router 58. A special purpose attendant/operator console is typically provided on a standard (or optional) basis. Similarly, the KTS is a customer premises telephone switching that allows the analog telephony devices (e.g., analog telephones 22a, 22b, 22c, 22d) of the premises to share the use of the telecommunication lines (lines 0-3) coupled thereto and connected to the PSTN-based trunks and VOIP-based trunks via the router 58. Note that a multi-channel trunk (e.g. T1 trunk) may be used to couple the premises 10′ to the local central office 26. In this configuration, a multi-channel trunk interface (i.e., T1 channel service unit (CSU) and channel bank) may be used to provide a plurality of trunks that interface to the analog telephony devices of the premises 10 via the voice router 58 and PBX/KTS 127. The multi-channel trunk interface functionality can be provided by one or more devices that are external to the voice router 58. Alternatively, portions of such functionality may be integral to the voice router 58. In addition, a multi-channel line (e.g., T1 line) may be used to couple the voice router 58 and PBX/KTS 127. In this configuration, a multi-channel line interface may be used to provide a plurality of lines that are coupled to the voice router 58. Such functionality can be provided by one or more devices that are external to the voice router 58. Alternatively, portions of such functionality may be integral to the voice router 58. In this embodiment, the other components of the system operate as described above with respect to FIGS. 1 through 11.

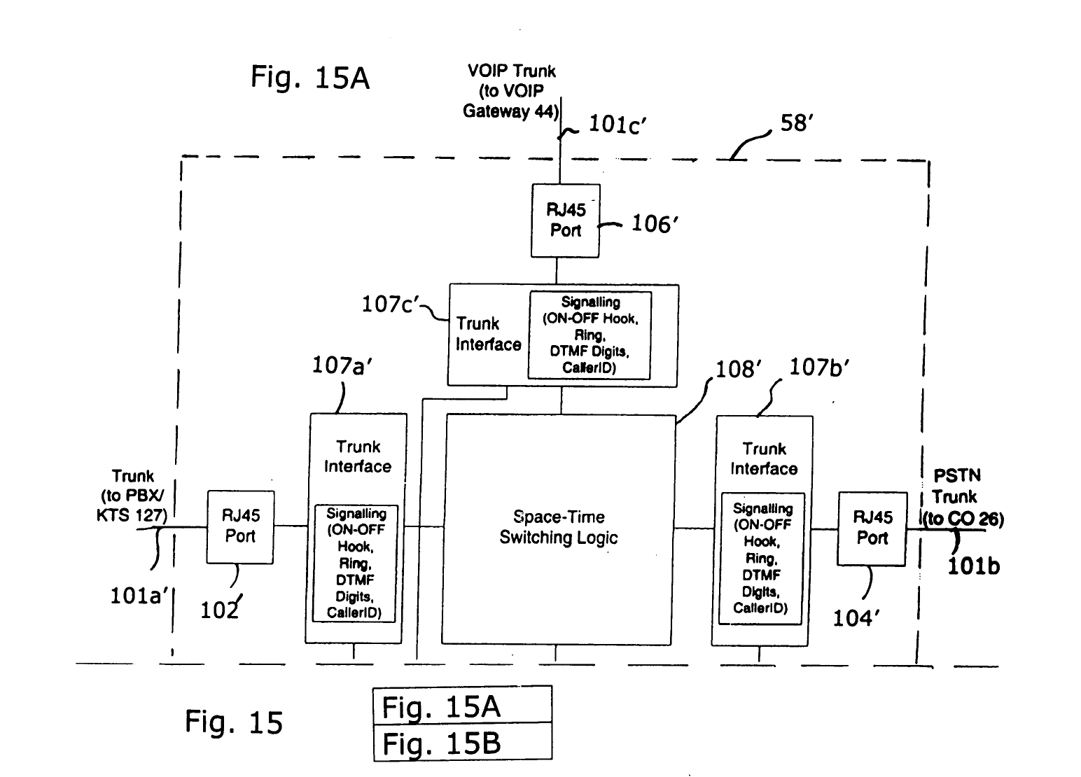

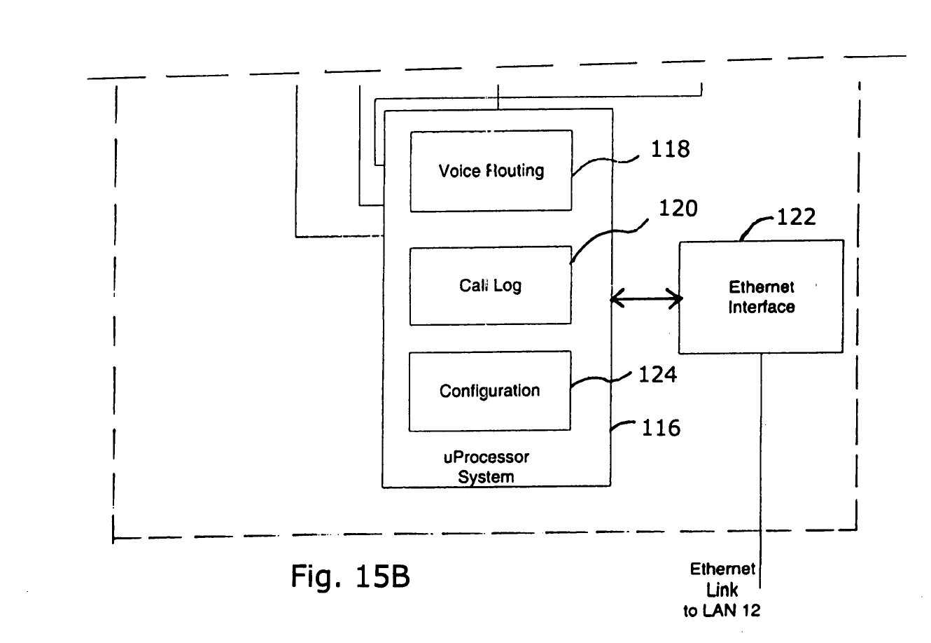

FIG. 15 illustrates an alternate embodiment of a voice routing apparatus in accordance with the present invention, which is particularly suitable for large scale applications that require the routing of calls over a large number of trunks. In this alternate embodiment, the routing apparatus 58′ will be typically disposed between a conventional private branch exchange (PBX) or key telephone system (KTS) 127 and the VOIP Gateway 44 and PSTN in a manner similar to that shown in FIG. 14. In this configuration, multi-channel trunks (e.g., T1 trunks) may be used to couple the voice router 58′ to the PBX/KTS system 127, to the VOIP gateway 44, and to the local Central Office 26, respectively. As is conventional, time slots on the multi-channel trunks are assigned to carry the signaling data (sometimes referred to as “ABCD” bits) and voice data for a particular call in digital form. Such signaling can be performed over assigned time slots (e.g., time slot 16 for a 30-channel E1 trunk) or over bits carried over the time slots (e.g., robbed-bits of a 24 channel T1 trunk) as is well known in the communication arts. Thus, such time slots are analogous to the lines and trunks of the systems previously described herein. In this alternate embodiment, a first multi-channel trunk 101a′ is operably coupled between the PBX/KTS system 127 and the RJ48 port 102′ of the voice router 58′, a second multi-channel trunk 101b′ is operably coupled between the RJ48 port 104‘of the voice router 58′ and the local central office 26 of the PSTN, and a third multi-channel trunk 101c′ is operably coupled between the RJ48 port 106′ of the voice router 58′ and the VOIP gateway 44 of the VOIP network. Trunk interface circuitry 107a′, 107b′ and 107c′ terminates the multi-channel trunks 101a′, 101b′, and 101c′, respectively, and provides signaling facilities (e.g., On/Off Hook, Ring, DTMF digit and CallerID signaling) for calls carried over the time slots of the multi-channel trunks. The signaling facilities of the trunk interfaces provide call related control signals to the microprocessor-based voice routing routine 118 as previously described herein. Space-time switching logic 108′ operates under the control of the microprocessor-based voice routing routine 118 to provide digital switching of voice data over the three multi-channel trunks 101a′, 101b′, and 110c. Such digital switching operations are analogous to the analog switching provided by the switch matrix 108 previously described herein. More specifically, the space-time switching logic 108′ carries out such digital switching by shifting in time and place the digital data carried over the time slots of the three multi-channel trunks 101a′, 110b′, and 110c′. The other components of the system operate as described above with respect to FIGS. 1 through 14.

There have been described and illustrated herein several embodiments of a system, method and apparatus that provide improved voice routing capabilities. While particular embodiments of the invention have been described, it is not intended that the invention be limited thereto, as it is intended that the invention be as broad in scope as the art will allow and that the specification be read likewise. Thus, while particular data structures and processing operations have been disclosed, it will be appreciated that other data structures and processing operations can be used to realize the improved voice routing capabilities of the present invention as described herein. In addition, while particular applications of the improved voice routing mechanisms and systems based thereon have been disclosed, it will be understood that such mechanisms can be similarly used in other applications and systems. For example, the voice routing mechanisms can be used to route calls over the PSTN Network and calls over a Wide Area Telephone Service (WATS) trunk. The WATS trunk provides a bulk savings plan for companies with a high volume of toll calls, such as telemarketing companies. In another example, the voice routing mechanisms can be used to route calls over different VOIP networks such as first VOIP network (with guaranteed QOS, reliable service but relatively expensive) and a second VOIP network (with no guaranteed QOS but relatively inexpensive). In another example, the voice routing mechanisms described herein need not interface to POTS-based analog telephony device, but can readily interface to a wide variety of telephony devices (and lines), such as IP telephony devices, in order to provide for intelligent call routing for such devices. Moreover, while particular configurations of lines, trunks, and multi-channel trunks have been disclosed, it will be appreciated that other configurations could be used as well. Furthermore, while the present invention as described above utilizes a microprocessor system to realize call/route processing and switch control, it will be appreciated that other logic means, including an application specific integrated circuit, programmable logic device or other logic device, can be used. It will therefore be appreciated by those skilled in the art that yet other modifications could be made to the provided invention without deviating from its spirit and scope as claimed.

1. In a system including at least one line operably coupled to a telephony device and a plurality of trunks operably coupled to diverse networks, a method of routing voice calls over the diverse networks comprising:
in response to an off-hook detect signal generated during initiation of an outgoing voice call by a telephony device operably coupled to a particular line, electrically connecting said particular line to at least two trunks;
simultaneously routing over said at least two trunks at least one Dual Tone Multi-Frequency (DTMF) digit tone generated in accordance with operations of the telephony device operably coupled to the particular line;
detecting and analyzing at least one DTMF digit tone generated in accordance with operations of the telephony device operably coupled to the particular line to determine a classification tag for the outgoing voice call; and
disconnecting said particular line from at least one trunk based upon said classification tag to enable the outgoing voice call to proceed over another one of said at least two trunks.

2. A method according to claim 1, wherein:
said at least two trunks are identified by accessing at least one table that provides an ordered list of trunk assignments associated with the particular line.

3. A method according to claim 2, wherein:
said at least one table comprises a first table that stores trunk assignments for a first call-type and a second table that stores trunk assignments for a second call-type.

4. A method according to claim 3, wherein:
said first call-type represents a local call type associated with at least one of local calls, toll-free calls and emergency calls, and said second call-type represents a long distance call type associated with at least one of long distance calls, international calls and site-to-site calls.

5. A method according to claim 4, wherein:
said diverse networks include a Public Switched Telephone Network (PSTN)-based network and an Internet-based Voice over IP (VOIP) network, said first table stores trunk assignments that preferentially assign PSTN trunks to local calls, and said second table stores trunk assignments that preferentially assign VOIP trunks to long distance calls.

6. A method according to claim 1, further comprising:
in response to a ring signal generated during initiation of an incoming voice call over a particular trunk, electrically connecting said particular trunk to at least one line operably coupled to a telephone device.

7. A method according to claim 6, wherein:
said at least one line is identified by accessing at least one table that provides an ordered list of line assignments associated with the particular trunk.

8. A method according to claim 6, wherein
said particular trunk is electrically connected to a plurality of lines, wherein said plurality of lines are identified by accessing at least one table that provides an ordered list of line assignments associated with the particular trunk.

9. A method according to claim 6, further comprising:
providing a data structure that provides a list of line assignments associated with caller ID information;
detecting caller identification (ID) information associated with said incoming voice call; and
accessing said data structure with said caller ID information to identify said at least one line that is connected to the particular trunk.

10. A method according to claim 6, further comprising:
communicating said caller ID information to a network device over a network link therebetween.

11. A method according to claim 6, further comprising:
electrically connecting said particular trunk to answering machine functionality in parallel with the electrical connection to said at least one line.

12. A method according to claim 1, wherein:
connection of said line to said plurality of trunks is accomplished by a switching matrix.

13. A method according to claim 1, wherein:
said line is realized by time slots on one multi-channel trunk, said plurality of trunks are realized by time slots on at least one other multi-channel trunk, and connection of said line to said plurality of trunks is accomplished by space and time shifting of digital data over the time slots of the one multi-channel trunk and the time slots of the at least one other multi-channel trunk.

14. In a system including a plurality of lines operably coupled to telephony devices and a plurality of trunks operably coupled to diverse networks, an apparatus for routing voice calls over the diverse networks comprising:
switching means that selectively connects a subset of said lines to a subset of said trunks;
off-hook detection circuitry that detects an off-hook condition during initiation of an outgoing voice call by a telephony device operably coupled to a particular line;
switch control means, coupled to said off-hook detection circuitry, that controls said switch matrix to connect said particular line to at least two trunks in response to an off-hook detect control signal provided thereto by said off-hook detection circuitry and simultaneously route over said at least two trunks at least one Dual Tone Multi-Frequency (DTMF) digit tone generated in accordance with operations by the telephony device operably coupled to the particular line;
DTMF detection circuitry, operably coupled to said switch control means, that detects at least one DTMF digit tone generated in accordance with the telephony device operably coupled to the particular line and that supplies DTMF digit data to said switch control means;
wherein said switch control means includes means for analyzing said DTMF digit data to determine a classification tag for the outgoing voice call, and means for controlling said switch matrix to disconnect said particular line from at least one trunk based upon said classification tag to enable the outgoing voice call to proceed over another one of said at least two trunks.

15. An apparatus according to claim 14, wherein:
said switch control means maintains at least one table that provides an ordered list of trunk assignments associated with the particular line, and accesses said at least one table to identify said at least two trunks.

16. An apparatus according to claim 14, wherein:
said at least one table comprises a first table that stores trunk assignments for a first call-type and a second table that stores trunk assignments for a second call-type.

17. An apparatus according to claim 16, wherein:
said first call-type represents a local call type associated with at least one of local calls, toll-free calls and emergency calls, and said second call-type represents a long distance call type associated with at least one of long distance calls, international calls and site-to-site calls.

18. An apparatus according to claim 17, wherein:
said diverse networks include a Public Switched Telephone Network (PSTN)-based network and an Internet-based Voice over IP (VOIP) network, said first table stores trunk assignments that preferentially assign PSTN trunks to local calls, and said second table stores trunk assignments that preferentially assign VOIP trunks to long distance calls.

19. An apparatus according to claim 18, wherein:
said VOIP trunks are operably coupled to a VOIP gateway, and said PSTN trunks are operably coupled to the PSTN.

20. An apparatus according to claim 19, wherein:
said apparatus in integrated with VOIP gateway functionality in a common system housing.

21. An apparatus according to claim 14, further comprising:
ring detect circuitry, operably coupled to said switch control means, that detects a ring signal generated during initiation of an incoming voice call over a particular trunk, and supplies a ring detect control signal to said switch control means;
wherein said switch control means operates to electrically connect said particular trunk to at least one line in response to said ring detect signal.

22. An apparatus according to claim 21, wherein:
said switch control means maintains at least one table that provides an ordered list of line assignments associated with the particular trunk, and accesses said at least one table to identify the at least one line connected to the particular trunk.

23. An apparatus according to claim 22, wherein:
said switch control means electrically connects said particular trunk to a plurality of lines, wherein said plurality of lines are identified by accessing the at least one table that provides an ordered list of line assignments associated with the particular trunk.

24. An apparatus according to claim 21, further comprising:
caller identification (ID) detection circuitry, operably coupled to said switch control means, that detects caller ID information associated with said incoming voice call;
wherein said switch control means maintains a data structure that provides a list of line assignments associated with caller ID information, and accessing said data structure with said caller ID information to identify said at least one line that is connected to the particular trunk.

25. An apparatus according to claim 24, further comprising:
means for communicating said caller ID information to a network device over a network link therebetween.

26. An apparatus according to claim 21, wherein:
said switch control means electrically connects said particular trunk to answering machine functionality in parallel with the electrical connection to said at least one line.

27. An apparatus according to claim 14, wherein:
said switch control means comprises a programmed microprocessor system.

28. An apparatus according to claim 14, wherein:
said switch control means maintains a call log of call information.

29. An apparatus according to claim 28, further comprising:
means for accessing said call log via user execution of a network-based utility.

30. An apparatus according to claim 14, further comprising:
means for manipulating configuration parameters of said apparatus via user execution of a network based utility.

31. An apparatus according to claim 12, wherein:
said switching means comprises a switch matrix.

32. An apparatus according to claim 3 1, wherein:
said switch matrix is adapted to electrically connect at least one line to a corresponding PSTN trunk in the event of power failure.

33. An apparatus according to claim 12, wherein:
said plurality of lines are realized by time slots on at least one multi-channel trunk, said plurality of trunks are realized by time slots on at least one other multi-channel trunk, and connection of said line to said plurality of trunks, and said switching means comprises switching logic that performs space and time shifting of digital data over the time slots of the multi-channel trunks.

34. A telephony system for a premises comprising:
a plurality of telephone devices located in said premises;
a plurality of lines operably coupled to telephony devices;
a plurality of trunks operably coupled to diverse networks; and
an apparatus for routing voice calls over the diverse networks including
switching means that selectively connects a subset of said lines to a subset of said trunks,
off-hook detection circuitry that detects an off-hook condition during initiation of an outgoing voice call by a telephony device operably coupled to a particular line,
switch control means, coupled to said off-hook detection circuitry, that controls said switch matrix to connect said particular line to at least two trunks in response to an off-hook detect control signal provided thereto by said off-hook detection circuitry and simultaneously route over said at least two trunks at least one Dual Tome Multi-Frequency (DTMF) digit tone generated in accordance with operations by the telephony device operably coupled to the particular line,
DTMF detection circuitry, operably coupled to said switch control means, that detects at least one DTMF digit tone generated in accordance with operations by the telephony device operably coupled to the particular line and that supplies DTMF digit data to said switch control means,
wherein said switch control means includes means for analyzing said DTMF digit data to determine a classification tag for the outgoing voice call, and means for controlling said switch matrix to disconnect said particular line from at least one trunk based upon said classification tag to enable the outgoing voice call to proceed over another one of said at least two trunks.

35. A system according to claim 34, wherein:
said switch control means maintains at least one table that provides an ordered list of trunk assignments associated with the particular line, and accesses said at least one table to identify said at least two trunks.

36. A system according to claim 35, wherein:
said at least one table comprises a first table that stores trunk assignments for a first call-type and a second table that stores trunk assignments for a second call-type.

37. A system according to claim 36, wherein:
said first call-type represents a local call type associated with at least one of local calls, toll-free calls and emergency calls, and said second call-type represents a long distance call type associated with at least one of long distance calls, international calls and site-to-site calls.

38. A system according to claim 37, wherein:
said diverse networks include a Public Switched Telephone Network (PSTN)-based network and an Internet-based Voice over IP (VOIP) network, said first table stores trunk assignments that preferentially assign PSTN trunks to local calls, and said second table stores trunk assignments that preferentially assign VOIP trunks to long distance calls.

39. A system according to claim 38, further comprising:
a VOIP gateway, located in said premises, that is operably coupled between said VOIP trunks and said VOIP network; and
a Network Interface Unit, located at said premises, that operably couples said PSTN trunks to said PSTN network.

40. A system according to claim 39, wherein:
said apparatus in integrated with VOIP gateway functionality in a common system housing.

41. A system according to claim 34, wherein:
said apparatus further comprises ring detect circuitry, operably coupled to said switch control means, that detects a ring signal generated during initiation of an incoming voice call over a particular trunk, and supplies a ring detect control signal to said switch control means;
wherein said switch control means operates, in response to said ring detect signal, to electrically connect said particular trunk to at least one line.

42. A system according to claim 41, wherein:
said switch control means maintains at least one table that provides an ordered list of line assignments associated with the particular trunk, and accesses said at least one table to identify the at least one line connected to the particular trunk.

43. A system according to claim 42, wherein:
said switch control means electrically connects said particular trunk to a plurality of lines, wherein said plurality of lines are identified by accessing the at least one table that provides an ordered list of line assignments associated with the particular trunk.

44. A system according to claim 41, wherein:
said apparatus further comprises caller identification (ID) detection circuitry, operably coupled to said switch control means, that detects caller ID information associated with said incoming voice call;
wherein said switch control means maintains a data structure that provides a list of line assignments associated with caller ID information, and accessing said data structure with said caller ID information to identify said at least one line that is connected to the particular trunk.

45. A system according to claim 44, further comprising:
means for communicating said caller ID information to a network device over a network link therebetween.

46. A system according to claim 41, wherein:
said switch control means electrically connects said particular trunk to answering machine functionality in parallel with the electrical connection to said at least one line.

47. A system according to claim 34, wherein:
said switch control means comprises a programmed microprocessor system.

48. A system according to claim 34, wherein:
said switch control means maintains a call log of call information.

49. A system according to claim 48, wherein:
said apparatus comprises means for accessing said call log via user execution of a network-based utility.

50. A system according to claim 34, further comprising:
means for manipulating configuration parameters of said apparatus via user execution of a network based utility.

51. A system according to claim 34, wherein:
said switching means comprises a switch matrix.

52. A system according to claim 51, wherein:
said switch matrix is adapted to electrically connect at least one line to a corresponding PSTN trunk in the event of power failure.

53. A system according to claim 34, wherein:
said plurality of lines are realized by time slots on at least one multi-channel trunk, said plurality of trunks are realized by time slots on at least one other multi-channel trunk, and connection of said line to said plurality of trunks, and said switching means comprises switching logic that performs space and time shifting of digital data over the time slots of the multi-channel trunks.
